(19) United States
(12) Patent Application Publication
(10) Pub. No.: US 2003/0026279 A1
(43) Pub. Date: Feb. 6, 2003

(54) Resource reservation scheme and packet scheduling scheme for file transfer

(76) Inventors: Tetsuya Onoda, Kanagawa-ken (JP); Hui Zhang, Petaluma, CA (US)

Correspondence Address: KILPATRICK STOCKTON LLP, Atten: Roger T. Frost, Suite 2800, 1100 Peachtree Street, Atlanta, GA, 30309-4530, US

(21) Appl. No.: 09/877,537

(22) Filed: Jun. 8, 2001

(51) Int. Cl. H04J 3/16

(52) U.S. Cl. 370/428; 370/439; 370/468

(57) ABSTRACT

A resource reservation for a file transfer at an ingress node, core nodes, and an egress node on a file transfer route in a packet switching network is realized by sequentially carrying out a control processing for determining a reserved rate function rrsv(t) indicating an output bandwidth at each node as a function of time t according to an input rate function rin(t) indicating an input bandwidth at each node as a function of time t and a vacant rate function rφ(t) indicating a vacant bandwidth at each node as a function of time t, and judging whether it is possible to accept the reservation request at each node or not according to whether a difference between the input rate function and the output rate function exceeds a buffer capacity available at each node or not.

### FIELD OF THE INVENTION

The present invention relates to a resource reservation scheme at a network and a packet scheduling scheme at a node for the purpose of transferring data file at high speed and high efficiency through a packet switching network.

### DESCRIPTION OF THE RELATED ART

The packet switching network such as the Internet provides the best effort service. Namely, when a total sum of bandwidths of communication traffics exceeds the network resource (transmission path bandwidth), the transfer rate is not guaranteed. For this reason, for the transfer of traffics that require the guaranteed transfer rate such as the real time transfer of video data, audio data, etc., there is a need to reserve the network resource somehow. The conventional resource reservation scheme in the packet switching network will now be described with reference to FIG. 1.

FIG. 1 shows a packet switching network formed by a sender 1, an ingress node 2, core nodes 3, an egress node 4 and a receiver 5 which are connected through transmission paths 6, and a flow chart for the conventional resource reservation scheme in this packet switching network.

The operation of the conventional resource reservation scheme is as follows. In the conventional resource reservation scheme such as RSVP, the resource reservation procedure is initiated by a request from the receiver 5. The request (bandwidth) from the receiver 5 is notified to the network by the sender 1. Namely the sender 1 notifies a bandwidth rnew requested by the receiver 5 to the ingress node 2 of the network.

The ingress node 2 transfers the reservation request to a next core node 3 along a packet transfer route to the receiver 5, and at this point, the ingress node 2 judges whether it is possible to accept the newly reservation requested bandwidth rnew or not in view of a bandwidth (R) of a transmission path to a next hop node (core node 3) and a total sum (Σr) of the currently existing reserved bandwidths. Namely, the ingress node 2 transfers the reservation request to the next hop node (core node 3) only when (Σr)+rnew<R is satisfied. When this condition is not satisfied, the network cannot accept the requested bandwidth rnew so that the ingress node 2 rejects the reservation request and returns a message indicating the rejection to the sender 1.

The reservation request accepted at the ingress node 2 will be subjected to the similar judgement at the next hop node (core node 3) and transferred to a next hop node on the transfer route to the receiver 5 only when it is possible to accept the reservation request. When the reservation request is rejected at some node, a message indicating the rejection is returned to the sender 1 similarly as in the case of the ingress node 2, and the reservation sequence is terminated.

A final reservation acceptance notice is returned from the egress node 4 to the sender 1 only when the reservation request is accepted at the egress node 4 of the network eventually, and the sender 1 can transfer data according to the bandwidth reserved by the receiver 5 only in this case.

In the conventional resource reservation scheme, whether it is possible to accept the reservation request or not is judged on a basis of the requested reservation rate. The reservation rate is a single value, and the judgement is based on whether an output bandwidth from each node has a room for accepting that value or not. The bandwidth that can be reserved by the resource reservation scheme is fixed, so that it is useful in the case requiring the transfer at a constant rate such as the real time transfer of the video data, audio data, etc., but it is not suitable for the case that does not require the transfer at a constant rate such as the file transfer.

In the case that does not require the transfer at a constant rate such as the file transfer, it would be possible to realize the efficient high speed transfer if it is possible to efficiently utilize the vacant bandwidth that is varying in time, but there has been no resource reservation scheme in which a variable reservation rate is possible.

In order to make the transfer rate variable according to the traffic state (congestion level) of the network, it has been inevitable to carry out the transfer by the best effort scheme without any reservation, so that it has been difficult to predict the eventual file transfer completion time in the case of transferring a large file. Also, in the case of reserving the bandwidth for the file transfer by using the conventional resource reservation scheme, it is possible to complete the file transfer at a predictable time, but it is the reservation based on a constant rate so that it has been impossible to improve the multiplexing efficiency in the file transfer.

### BRIEF SUMMARY OF THE INVENTION

It is therefore an object of the present invention to provide a resource reservation scheme and a packet scheduling scheme for the file transfer, in which it is possible to reserve the vacant bandwidth of the network that is varying in time for the file transfer, obtain the predicted file transfer completion time at a time of the reservation, and set the actual packet output rate from each node in accordance with the reserved bandwidth for the file transfer that is varying in time, so as to improve the multiplexing efficiency of the file transfer and realize a service class for guaranteeing the completion of the file transfer by the predicted file transfer completion time.

According to one aspect of the present invention there is provided a method of resource reservation for a file transfer at an ingress node, core nodes, and an egress node on a file transfer route in a packet switching network, comprising the steps of: (a) receiving a reservation request for the file transfer from a sender or a receiver at the ingress node; (b) sequentially carrying out a control processing at each node among the ingress node, the core nodes and the egress node, the control processing being a processing for determining a reserved rate function rrsv(t) indicating an output bandwidth at each node as a function of time t according to an input rate function rin(t) indicating an input bandwidth at each node as a function of time t and a vacant rate function rφ(t) Iindicating a vacant bandwidth at each node as a function of time t, and judging whether it is possible to accept the reservation request at each node or not according to whether a difference between the input rate function and the output rate function exceeds a buffer capacity available at each node or not; (c) sequentially transferring the reservation request from each node among the ingress node and the core nodes to a next hop node on the file transfer route when it is possible to accept the reservation request at each node, or rejecting the reservation request when it is not possible to accept the reservation request at each node; (d) accepting the reservation request when the egress node judges that it is possible to accept the reservation request, or rejecting the reservation request otherwise; and (e) reserving the output bandwidth at each node among the ingress node, the core nodes and the egress node as indicated by the reserved rate function rrsv(t) of each node when the reservation request is accepted.

According to another aspect of the present invention there is provided a method of packet scheduling in a packet switching network for transferring packets of a file from a sender to a receiver, through an ingress node, core nodes, and an egress node on a file transfer route, comprising the steps of: setting a deadline td for transmitting each packet at each node on a file transfer route, as td=max[tarv+l/rin, tx], where tarv is an arrival time of each packet at each node, l is a packet length, rin is an input rate by which the file is to be transmitted from the sender to the packet switching network, and tx is a time at which an input data amount and an output data amount at each node coincide; and selecting one packet among packets buffered in each node which has the deadline td that is smallest among the packets buffered in each node, and transmitting said one packet from each node.

According to another aspect of the present invention there is provided a packet switching network system formed by a plurality of nodes, for carrying out a resource reservation for a file transfer at an ingress node, core nodes, and an egress node on a file transfer route, wherein; the ingress node has a unit configured to receive a reservation request for the file transfer from a sender or a receiver; each one of the ingress node, the core nodes and the egress node has a unit configured to carry out a control processing for determining a reserved rate function rrsv(t) indicating an output bandwidth at each node as a function of time t according to an input rate function rin(t) indicating an input bandwidth at each node as a function of time t and a vacant rate function rφ(t) indicating a vacant bandwidth at each node as a function of time t, and judging whether it is possible to accept the reservation request at each node or not according to whether a difference between the input rate function and the output rate function exceeds a buffer capacity available at each node or not; each one of the ingress node and the core nodes has a unit configured to transfer the reservation request to a next hop node on the file transfer route when it is possible to accept the reservation request at each node, or reject the reservation request when it is not possible to accept the reservation request at each node, such that the reservation request is sequentially transferred from the ingress node through the core nodes to the egress node while the control processing is sequentially carried out at each node among the ingress node, the core nodes and the egress node; the egress node has a unit configured to accept the reservation request when the egress node judges that it is possible to accept the reservation request, or reject the reservation request otherwise; and each one of the ingress node, the core nodes and the egress node has a unit configured to reserve the output bandwidth at each node as indicated by the reserved rate function rrsv(t) of each node when the reservation request is accepted.

According to another aspect of the present invention there is provided a packet switching network system formed by a plurality of nodes, for transferring packets of a file from a sender to a receiver, through an ingress node, core nodes, and an egress node on a file transfer route, wherein; each node has a unit configured to set a deadline td for transmitting each packet at each node, as td=max[tarv+l/rin, tx], where tarv is an arrival time of each packet at each node, l is a packet length, rin is an input rate by which the file is to be transmitted from the sender to the packet switching network, and tx is a time at which an input data amount and an output data amount at each node coincide; and each node has a unit configured to select one packet among packets buffered in each node which has the deadline td that is smallest among the packets buffered in each node, and transmit said one packet from each node.

According to another aspect of the present invention there is provided a method of resource reservation for a file transfer at a node device which is one of an ingress node, core nodes, and an egress node on a file transfer route in a packet switching network, comprising the steps of: (a) receiving a reservation request for the file transfer from a sender or a receiver if the node device is the ingress node; (b) carrying out a control processing for determining a reserved rate function rrsv(t) indicating an output bandwidth at the node device as a function of time t according to an input rate function rin(t) indicating an input bandwidth at the node device as a function of time t and a vacant rate function rφ(t) indicating a vacant bandwidth at the node device as a function of time t, and judging whether it is possible to accept the reservation request at the node device or not according to whether a difference between the input rate function and the output rate function exceeds a buffer capacity available at the node device or not; (c) transferring the reservation request to a next hop node on the file transfer route when it is possible to accept the reservation request at the node device, or rejecting the reservation request when it is not possible to accept the reservation request at the node device, if the node device is one of the ingress node and the core nodes; (d) accepting the reservation request when it is possible to accept the reservation request, or rejecting the reservation request otherwise, if the node device is the egress node; and (e) reserving the output bandwidth at the node device as indicated by the reserved rate function rrsv(t) of the node device when the reservation request is accepted.

According to another aspect of the present invention there is provided a method of packet scheduling in a packet switching network for transferring packets of a file from a sender to a receiver, at a node device which is one of an ingress node, core nodes, and an egress node on a file transfer route, comprising the steps of: setting a deadline td for transmitting each packet at the node device on a file transfer route, as td=max[tarv+l/rin, tx], where tarv is an arrival time of each packet at the node device, l is a packet length, rin is an input rate by which the file is to be transmitted from the sender to the packet switching network, and tx is a time at which an input data amount and an output data amount at the node device coincide; and selecting one packet among packets buffered in the node device which has the deadline td that is smallest among the packets buffered in the node device, and transmitting said one packet from the node device.

According to another aspect of the present invention there is provided a node device for carrying out a resource reservation for a file transfer as one of an ingress node, core nodes, and an egress node on a file transfer route in a packet switching network, the node device comprising: a first unit configured to receive a reservation request for the file transfer from a sender or a receiver if the node device is the ingress node; a second unit configured to carry out a control processing for determining a reserved rate function rrsv(t) indicating an output bandwidth at the node device as a function of time t according to an input rate function rin(t) indicating an input bandwidth at the node device as a function of time t and a vacant rate function rφ(t) indicating a vacant bandwidth at the node device as a function of time t, and judging whether it is possible to accept the reservation request at the node device or not according to whether a difference between the input rate function and the output rate function exceeds a buffer capacity available at the node device or not; a third unit configured to transfer the reservation request to a next hop node on the file transfer route when it is possible to accept the reservation request at the node device, or reject the reservation request when it is not possible to accept the reservation request at the node device, if the node device is one of the ingress node and the core nodes; a fourth unit configured to accept the reservation request when it is possible to accept the reservation request, or reject the reservation request otherwise, if the node device is the egress node; and a fifth unit configured to reserve the output bandwidth at the node device as indicated by the reserved rate function rrsv(t) of the node device when the reservation request is accepted.

According to another aspect of the present invention there is provided a node device for carrying out a packet scheduling in a packet switching network for transferring packets of a file from a sender to a receiver, as one of an ingress node, core nodes, and an egress node on a file transfer route, the node device comprising: a first unit configured to set a deadline td for transmitting each packet at the node device on a file transfer route, as td=max[tarv+l/rin, tx], where tarv is an arrival time of each packet at the node device, t is a packet length, rin is an input rate by which the file is to be transmitted from the sender to the packet switching network, and tx is a time at which an input data amount and an output data amount at the node device coincide; and a second unit configured to select one packet among packets buffered in the node device which has the deadline td that is smallest among the packets buffered in the node device, and transmit said one packet from the node device.

According to another aspect of the present invention there is provided a computer usable medium having computer readable program codes embodied therein for causing a computer to function as a node device for carrying out a resource reservation for a file transfer as one of an ingress node, core nodes, and an egress node on a file transfer route in a packet switching network, the computer readable program codes include: a first computer readable program code for causing said computer to receive a reservation request for the file transfer from a sender or a receiver if the node device is the ingress node; a second computer readable program code for causing said computer to carry out a control processing for determining a reserved rate function rrsv(t) indicating an output bandwidth at the node device as a function of time t according to an input rate function rin(t) indicating an input bandwidth at the node device as a function of time t and a vacant rate function rφ(t) indicating a vacant bandwidth at the node device as a function of time t, and judging whether it is possible to accept the reservation request at the node device or not according to whether a difference between the input rate function and the output rate function exceeds a buffer capacity available at the node device or not; a third computer readable program code for causing said computer to transfer the reservation request to a next hop node on the file transfer route when it is possible to accept the reservation request at the node device, or reject the reservation request when it is not possible to accept the reservation request at the node device, if the node device is one of the ingress node and the core nodes; a fourth computer readable program code for causing said computer to accept the reservation request when it is possible to accept the reservation request, or reject the reservation request otherwise, if the node device is the egress node; and a fifth computer readable program code for causing said computer to reserve the output bandwidth at the node device as indicated by the reserved rate function rrsv(t) of the node device when the reservation request is accepted.

According to another aspect of the present invention there is provided a computer usable medium having computer readable program codes embodied therein for causing a computer to function as a node device for carrying out a packet scheduling in a packet switching network for transferring packets of a file from a sender to a receiver, as one of an ingress node, core nodes, and an egress node on a file transfer route, the computer readable program codes include: a first computer readable program code for causing said computer to set a deadline td for transmitting each packet at the node device on a file transfer route, as td=max[tarv+l/rin, tx], where tarv is an arrival time of each packet at the node device, l is a packet length, rin is an input rate by which the file is to be transmitted from the sender to the packet switching network, and tx is a time at which an input data amount and an output data amount at the node device coincide; and a second computer readable program code for causing said computer to select one packet among packets buffered in the node device which has the deadline td that is smallest among the packets buffered in the node device, and transmit said one packet from the node device.

Other features and advantages of the present invention will become apparent from the following description taken in conjunction with the accompanying drawings.

### BRIEF DESCRIPTION OF THE DRAWINGS

FIG. 1 is a diagram showing an exemplary packet switching network and a flow chart for a conventional resource reservation scheme in correspondence.

FIG. 2 is a diagram showing an exemplary configuration of a packet switching network system to be used in one embodiment of the present invention.

FIG. 3 is a block diagram showing an exemplary configuration of a node device for an ingress node in the packet switching network of FIG. 2.

FIG. 4 is a block diagram showing an exemplary configuration of a node device for a core/egress node in the packet switching network of FIG. 2.

FIG. 5 is a graph showing a vacant bandwidth of an output link at an ingress node in the packet switching network of FIG. 2 as a function of time.

FIG. 6 is a graph showing an example of integrated values of rrsv(t) and rin(t) according to one embodiment of the present invention.

FIG. 7 is a table summarizing four operations to be used in updating rφ(t) according to one embodiment of the present invention.

FIGS. 8A and 8B are graphs showing exemplary results of the four operations shown in FIG. 7.

FIG. 9 is a graph showing an example of integrated values of two approximate functions rΛ(t) and rY(t) according to one embodiment of the present invention.

FIG. 10 is a table summarizing input start time, input end time and input rate for three blocks used in calculating rrsv(t) at a core/egress node in the packet switching network of FIG. 2.

FIG. 11 is a flow chart for a call admission control sequence to be carried out sequentially at nodes in the packet switching network of FIG. 2.

FIG. 12 is a diagram showing an exemplary rrsv(t) reserved by the resource reservation scheme and its relation to values of a deadline to be used in the packet scheduling scheme according to one embodiment of the present invention.

FIG. 13 is a diagram showing a simulation model used in a computer simulation for confirming effects of the present invention.

FIG. 14 is a graph showing a computer simulation result for the resource reservation scheme obtained by using the computer simulation model of FIG. 13 under one condition.

FIG. 15 is a graph showing a computer simulation result for the resource reservation scheme obtained by using the computer simulation model of FIG. 13 under another condition.

FIG. 16 is a graph showing a computer simulation result for a Drop Tail scheme obtained by using the computer simulation model of FIG. 13 for the sake of comparison.

FIG. 17 is a diagram showing a computer simulation result for the packet scheduling scheme obtained by using the simulation model of FIG. 13.

FIG. 18 is a table summarizing statistical data of the computer simulation result for the packet scheduling scheme shown in FIG. 17.

FIG. 19 is a flow chart showing an outline of the overall procedure according to one embodiment of the present invention.

FIG. 20 is a flow chart for a call admission control processing according to one embodiment of the present invention.

FIG. 21 is a flow chart for an operation of an ingress node in the resource reservation scheme according to one embodiment of the present invention.

FIG. 22 is a flow chart for an operation of a core node in the resource reservation scheme according to one embodiment of the present invention.

FIG. 23 is a flow chart for an operation of an egress node in the resource reservation scheme according to one embodiment of the present invention.

FIG. 24 is a flow chart for one operation of an ingress node in the packet scheduling scheme according to one embodiment of the present invention.

FIG. 25 is a flow chart for another operation of an ingress node in the packet scheduling scheme according to one embodiment of the present invention.

FIG. 26 is a flow chart for one operation of a core/egress node in the packet scheduling scheme according to one embodiment of the present invention.

FIG. 27 is a flow chart for another operation of a core/egress node in the packet scheduling scheme according to one embodiment of the present invention.

### DETAILED DESCRIPTION OF THE INVENTION

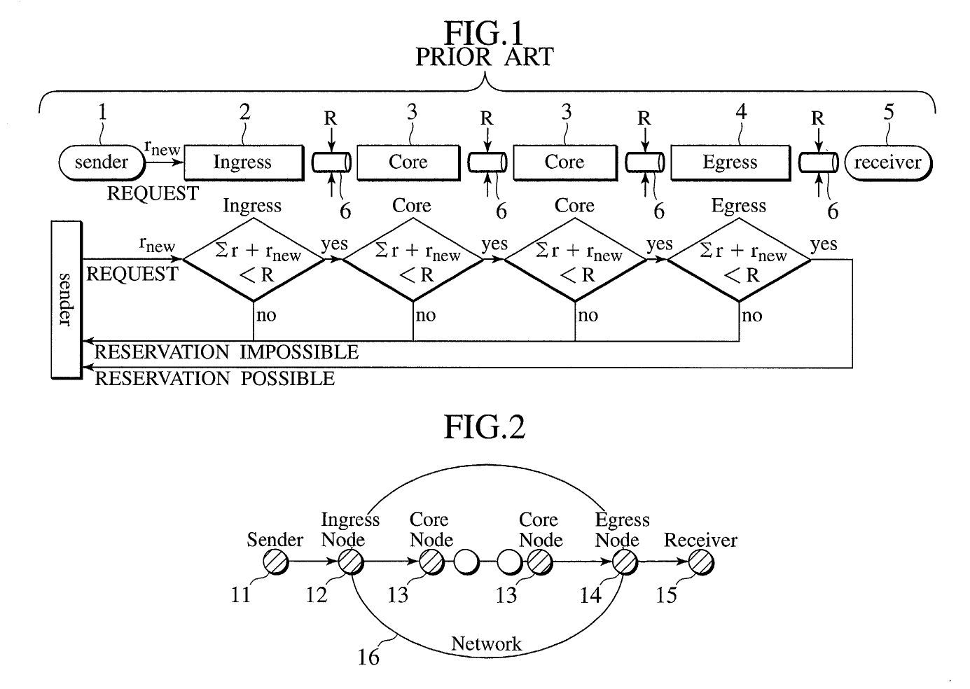

Referring now to FIG. 2 to FIG. 27, one embodiment of the resource reservation scheme and the packet scheduling scheme according to the present invention will be described in detail.

In the resource reservation scheme of this embodiment, the network resource reservation (bandwidth reservation) for the file transfer is realized by utilizing the facts that the file size is known in advance and there is a tolerable delay jitter, which are two characteristics of the file transfer.

Unlike the real time communications, in the file transfer, the overall size of data to be transferred is already known before starting the transfer. For this reason, it is possible for the sender or the receiver to declare the file size at a time of the resource reservation. By declaring the file size, each network for carrying out the transfer can make a setting as to how long the bandwidth to be reserved will be necessary at a time reserving the resource.

The file transfer also significantly differs from the real time communications in that the file transfer is not influenced by the delay jitter among packets. The file is transferred in forms of packets subdividing the file on the packet switching network. In the case of the real time transfer, there is a need to transfer at a constant rate so that the delay jitter among packets must be suppressed to a small value. In contrast, in the file transfer, the rate at which data are outputted from each node during the file transfer may vary so that there is no need to suppress the delay jitter among packets to a small value. For this reason, it is possible to vary the output rate of the file transfer adaptively to a state of the vacant bandwidth in the output link from each node. Even when there is no vacant bandwidth corresponding to the input rate at a time of the reservation request for the file transfer, it is possible to accept the file transfer so that the multiplexing efficiency of the file transfer can be improved.

In this resource reservation scheme, at a time of transferring the reservation request to a next hop node on the file transfer route, instead of notifying the time function rrsv(t) of the output bandwidth reserved at the node, approximate functions of rrsv(t) is notified to the next hop node. Note that rrsv(t) is a function of a time t that is determined by the time function rφ(t) of the vacant bandwidth of the node and the input, which can take a complicated form. Consequently, by using the approximate functions of rrsv(t) rather than rrsv(t) itself, it is possible to simplify the notification of the reservation request among the nodes. Here, two approximate functions rΛ(t) and rY(t) are to be selected to satisfy the condition of ∫rΛ(t)dt≦∫rrsv(t)dt≦∫rY(t)dt(∀T). That is, the integrated value of the output data amount of the file is always less than or equal to rrsv(t) according to rΛ(t), and always greater than or equal to rrsv(t) according to rY(t). Thus the integrated value of the data output amount according to rrsv(t) is always located between rΛ(t) an rY(t).

When rΛ(t) is notified, the next hop node regards this as an input function rin(t) and uses it in calculation of rrsv(t) and a time tx at which the input data amount and the output data amount coincide. Then, a difference between rrsv(t) so obtained and the input rin(t) is used as a criterion for judging whether or not it is possible to accept the new reservation request for the file transfer. Alternatively, rY(t) notified from the previous hop node can be used instead of the input rin(t). By selecting Isimple functions such as linear functions for rΛ(t) and rY(t) and notifying parameters for expressing them to the next hop node instead of rrsv(t) on one hand, and by using the notified rΛ(t) and rY(t) at the next hop node in determining rrsv(t) and judging whether it is possible to accept the new reservation request or not as described above, it is possible to simplify the calculation of tx and rrsv(t) and the notification of the reservation request for the file transfer among the nodes.

Also, in the present invention, at a time of carrying out the file transfer for which the resource reservation is made, the reserved bandwidth varies in time so that there is a need for each node to output packets in accordance with the bandwidth that is varying in time. In the conventional packet scheduling scheme, it is possible to maintain the constant packet output rate but it is not possible to change the packet output rate in accordance with the varying reserved bandwidth.

For this reason, in this embodiment, the packet output rate is changed in accordance with the varying reserved bandwidth by setting tx obtained above as a deadline for the output time at each node which is to be set in each packet rather than using a fixed value obtained from the constant rate. Here, tx is a time at which the amount of data that arrived to each node and stored in a buffer becomes zero, which is a time at which the input rate and the output rate becomes equal as the entered packets will be outputted without being stored in a buffer. By shifting the deadline to be set in the packets to tx uniformly, it is possible to change the output time of the packet that has arrived to the node before tx according to the state of the vacant bandwidth at the node so that it is possible to change the packet output rate in accordance with the reserved bandwidth that is varying in time.

Now, the resource reservation scheme and the packet scheduling scheme for the file transfer according to this embodiment will be described in further details.

FIG. 2 shows a configuration of a network to be used in this embodiment, which comprises a sender 11, an ingress node 12, core nodes 13, an egress node 14, and a receiver 15, where the ingress node 12, the core nodes 13 and the egress node 14 belong to a network 16.

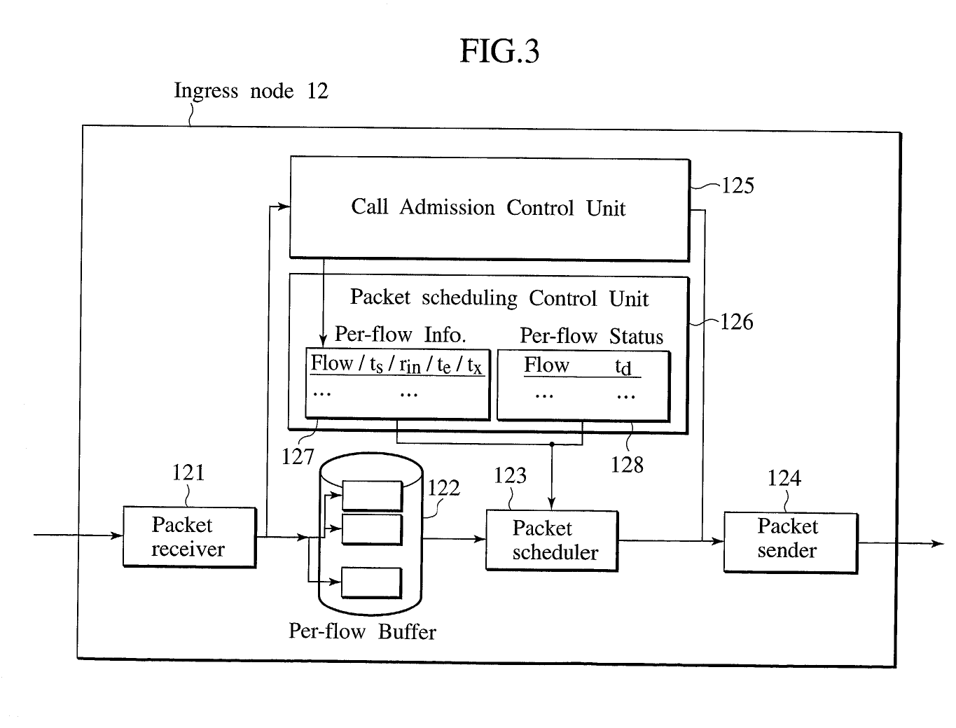

As shown in FIG. 3, the ingress node 12 comprises a packet receiver 121, a per-flow buffer 122, a packet scheduler 123, a packet sender 124, a call admission control unit 125, and a packet scheduling control unit 126 having a per-flow information 127 and a per-flow status 128.

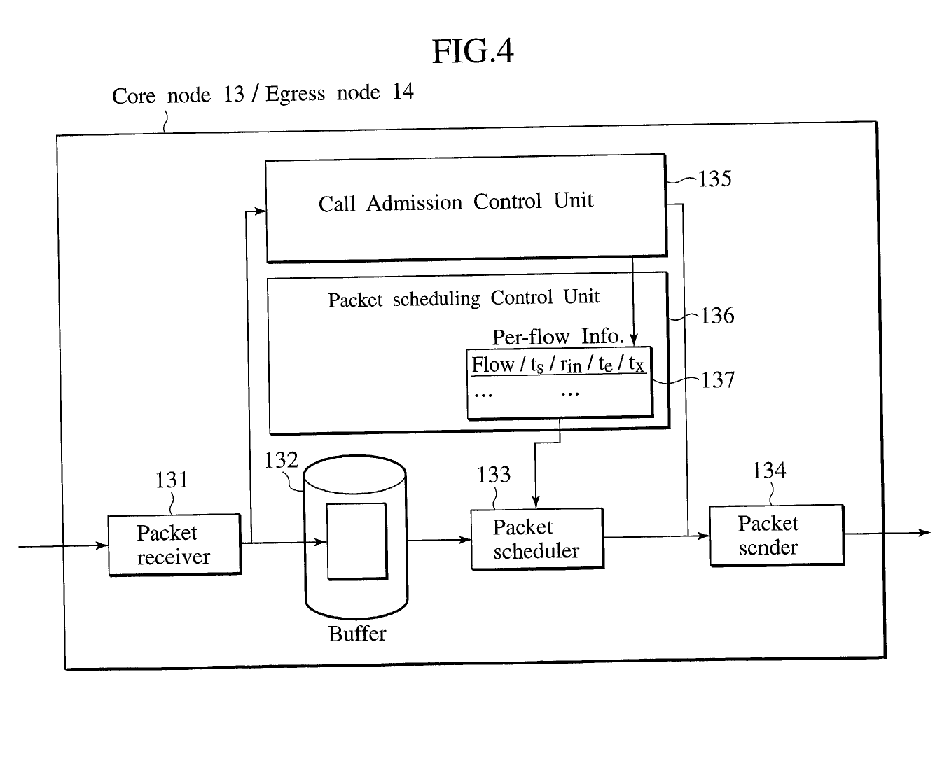

As shown in FIG. 4, each of the core nodes 13 and the egress node 14 comprises a packet receiver 131, a buffer 132, a packet scheduler 133, a packet sender 134, a call admission control unit 135, and a packet scheduling control unit 136 having a per-flow information 137.

In this embodiment, the network resource reservation request for the file transfer is issued from the sender 11, and received at the ingress node 12. The reservation request for the file transfer that is to be received at the ingress node 12 comprises three elements: a start time ts at which the sender 11 intends to start transmission to the network 16, a scheduled ending time te, and an input rate rin. The file size B can be calculated from these three elements as rin(te−ts).

Then, the judgement as to whether it is possible to accept the received reservation request or not is made at the ingress node 12, and if it is possible, the reservation request is transferred to a next hop node. In this way, the reservation request is transferred sequentially to the core nodes 13 and the egress node 14, while the judgement as to whether it is possible to accept the reservation request or not is made at each node. When the egress node 14 judges that it is possible to accept the reservation request eventually, a reservation acceptance notice is sent to the sender 11 along with a predicted completion time for the file transfer from the egress node 14 to the receiver 15. In the judgement as to whether it is possible to accept the reservation request or not, if it is judged as not possible to accept the reservation request at any of the ingress node 12, the core nodes 13 and the egress node 14, a reservation rejection notice is sent to the sender 11, and the transfer of the reservation request to the subsequent nodes is interrupted.

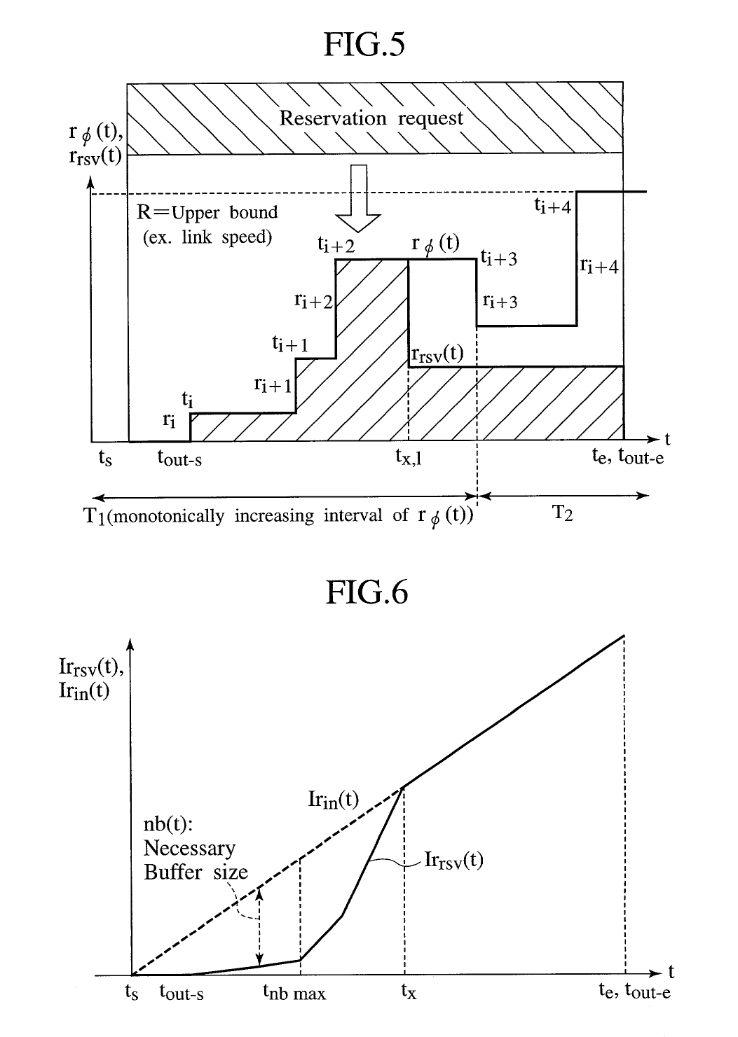

Next, the exemplary method for judging whether it is possible to accept the reservation request or not will be described with references to FIG. 5 to FIG. 11.

FIG. 5 shows the vacant bandwidth of the output link at the ingress node 12 as a function rφ(t) of time. The bandwidth reservation for the file transfer is completed within a finite time according to the file size, so that the vacant bandwidth rφ(t) has different values at different times as shown in FIG. 5, which can be expressed as a function of time. A value R on the Y-axis in FIG. 5 indicates an upper bound, which corresponds to the output link speed of the node, for example.

Suppose that the file transfer request {rin, ts, te} is issued from the sender 11 when the vacant bandwidth rφ(t) as shown in FIG. 5 exists. In this embodiment, this request is expressed as a time function rin(t)=rin[ts, te). In the example shown in FIG. 5, the vacant bandwidth rφ(t) is zero at a time ts, so that the reservation request with the input rate rin cannot be accepted according to the conventional resource reservation scheme. However, in the resource reservation scheme of this embodiment, the reservation request is accepted by delaying the output start time from ts and changing the output rate at the node to a value different from rin, even when there is no vacant bandwidth corresponding to rin at a time ts as in FIG. 5.

In this example, rφ(t) becomes non-zero at a time ti, so that rin(t) is allocated to the vacant bandwidth starting from ti. The allocated output bandwidth is indicated in FIG. 5 as a time function rrsv(t). The change from the input rate rin(t) to rrsv(t) implies that the file data are to be buffered at the node. Namely, in this resource reservation scheme, the whether it is possible to accept the reservation request or not is judged according to whether the buffered amount of the file data at the node resulting from the change from rin(t) to rrsv(t) would exceed a tolerable amount (a buffer size or the like) at the node or not, and not according to the amount of the vacant bandwidth available at the input start time ts.

In the following, the method for determining rrsv(t) and the method for judging whether it is possible to accept the reservation request or not (which will be referred to as Call Admission Control (CAC) hereafter) at the ingress node 12 will be described first, and then the method for determining rrsv(t) and the CAC method at the core node 13 or the egress node 14 will be described next.

<Method for Determining rrsv(t) at the Ingress Node>

As described above, in the resource reservation scheme of this embodiment, rrsv(t) is obtained according to the vacant bandwidth, and whether it is possible to accept the reservation request or not is judged according to the amount of buffer capacity required in conjunction with the change of the input rate into rrsv(t). To this end, there is a need for the node to manage the vacant bandwidth and the vacant buffer size as functions of time. Here, these two functions will be denoted as rφ(t) and bφ(t) respectively. Also, in this embodiment, the management of rφ(t) and bφ(t) is realized by using the following three series defined with respect to a time t:

{ti|ti+1>ti}i≧1

[rt i|rt i=rφ(ti+1)−rφ(ti)}

{bt i|bt i=bφ(ti)}

where bφ(t) indicates a vacant buffer capacity (a vacant buffer size or the like) at the node, whose upper bound will be denoted as C. The initial states of these three series are [ti=0}, {rt i=R}, and {bt i=C}.

The ingress node 12 attempts to allocate rrsv(t) according to the reservation request rin(t) and the vacant bandwidth rφ(t) as shown in FIG. 5. In the example of FIG. 5, the start of the output at rrsv(t) is delayed to tout−s, and the allocated bandwidth at a time tout−s is less than rin, but a greater bandwidth is allocated after a time ti+2 at which the vacant bandwidth becomes significantly greater than rin such that a backlog of the output data amount with respect to the input data amount can be resolved. In the example of FIG. 5, it is calculated that the data buffered at the node due to the backlog of the output with respect to the input becomes 0 at a time tx, so that the bandwidth allocated to rrsv(t) becomes equal to rin. Here, tx is a time at which the input data amount and the output data amount at the node are predicted to become equal. This situation can be expressed as follows.

$${r}_{i n} ( {t}_{x} - {t}_{s} ) = {\int }_{{t}_{s}}^{{t}_{x}} {r}_{rsv} ( t ) ⅆ t = {\int }_{{t}_{s}}^{{t}_{x}} {r}_{φ} ( t ) ⅆ t \qquad ( 1 )$$

From this equation (1), tx can be determined uniquely at an interval where rφ(t) is monotonically increasing. The monotonically increasing interval of rφ(t) will be denoted as Tk=[ta,k, tb,k](1≦k≦kmax), where ta,k≦ts and tb,kmax≦tout−e. The monotonically increasing interval Tk is an interval enclosed by two negative elements in the series (rti). Therefore the equation (1) can be rewritten as the following equation (2):

$${Ir}_{i n} ( t ) = {\sum }_{∀ ti > 0} {r}_{ti} \{ max [ {t}_{x , k} , {t}_{i} ] - max [ {t}_{s} , {t}_{i} ] \} \qquad ( 2 )$$

where If(x) stands for ∫f(t)dt[ts, X], and this notation will be used hereafter.

From the equation (2), tx,k that is uniquely determined in the monotonically increasing interval Tk can be defined as follows:

$${t}_{x , k} = {min}_{{t}_{a , k} ≦ t ≦ {t}_{b , k}} [ {α}_{k} ( t ) / {β}_{k} ( t ) ] \qquad ( 3 )$$

where

$${α}_{k} ( t ) = {\sum }_{∀ 0 < {t}_{i} ≦ t} {r}_{ti} max [ {t}_{s} , {t}_{a , k} , {t}_{i} ] - {r}_{i n} max [ {t}_{s} , {t}_{a , k} ] + {m}_{k - 1} \\ {β}_{k} ( t ) = {\sum }_{∀ 0 < {t}_{i} ≦ t} {r}_{ti} - {r}_{i n} . \qquad ( 4 )$$

In the equation (4), mk−1 is a remaining data amount that could not have been allocated to the vacant bandwidth rφ(t) by the time of the immediately previous monotonically increasing interval Tk−1. Here, mk can be defined as follows.

M∅=0

mk=max[0, μk(tx, k) (tx, k−tb, k)] (5)

Also, when a value of tx, k obtained by the equation (3) exceeds the end tb, k of the monotonically increasing interval or the end te of the input, there is a need to correct a value of tx, k as follows.

$${t}_{b , k} ( {t}_{x , k} > {t}_{b , k} ) , \frac{{α}_{k} ( {t}_{x , k} ) + {r}_{i n} {t}_{s}}{{β}_{k} ( {t}_{x , k} ) + {r}_{i n}} ( {t}_{x , k} > {t}_{e} ) \qquad ( 6 )$$

Using tx, k obtained above, rrsv(t) can be defined as follows.

In Tk=[ta, k, tb, k),

$${r}_{rsv} ( t ) = \{ \begin{matrix}{r}_{φ} ( t ) , & {t}_{a , k} ≦ t < {t}_{x , k} \\ {r}_{i n} , & {t}_{x , k} ≦ t < {t}_{b , k}\end{matrix} \qquad ( 7 )$$

Among tx, k, a maximum value for which tx, k≠ta, k holds will be defined as tx with respect to the entire input. Also, in the definition of the equation (7), boundary values rᵣₛᵥ(tx, k ), rrsv(tout−s, k) and rrsv(tout−e, k) will be denoted as rx, k, rout−s, k and rout−e, k which can be expressed respectively as follows.

$$\begin{matrix}{r}_{x , k} = {\sum }_{∀ {t}_{i} < {t}_{x , k}} {r}_{ti} \\ {r}_{out - s} = min [ {r}_{i n} , {\sum }_{∀ {t}_{i} ≦ {t}_{out - s}} {r}_{ti} ] \\ {r}_{out - e} = \{ \begin{matrix}{r}_{i n} , & {t}_{out - e} ≦ {t}_{x} \\ {r}_{x , k} , & {t}_{out - e} = {t}_{x}\end{matrix}\end{matrix} \qquad ( 8 )$$

<CAC Method at the Ingress Node>

FIG. 6 shows an example of the integrated value Irrsv(t) of rrsv(t). In FIG. 6, a dashed line indicates the integrated value Irin=l (t) of the input rin(t). A difference between the dashed line Irin(t) and the solid line Irrsv(t) indicates a buffer size required at the node in order to accept the reservation request. As shown in FIG. 6, the necessary buffer size becomes zero at tx, k if mk is zero in each monotonically increasing interval Tk of rφ(t). Here, the buffer size necessary at a time ti will be denoted as nb(ti). Using the equations (3) and (4), this nb(ti) can be expressed as follows.

nb(ti)=Irin(ti)−Irrsv(ti)

$$\begin{matrix}nb ( {t}_{i} ) = {Ir}_{i n} ( {t}_{i} ) - {Ir}_{rsv} ( {t}_{i} ) \\ = \{ \begin{matrix}{α}_{k} ( {t}_{i} ) - {β}_{k} ( {t}_{i} ) , & {t}_{i} < {t}_{x , k} \\ {m}_{k} , & ti ≧ {t}_{x , k}\end{matrix}\end{matrix} \qquad ( 9 )$$

Then, using this equation (9), the reservation request acceptance judgement of the CAC is carried out as follows.

CAC test: For all ti satisfying ts≦ti≦tout−e, if the inequality:

bti−nb(ti)≦0 (10)

holds, then the ingress node can accept the reservation request.

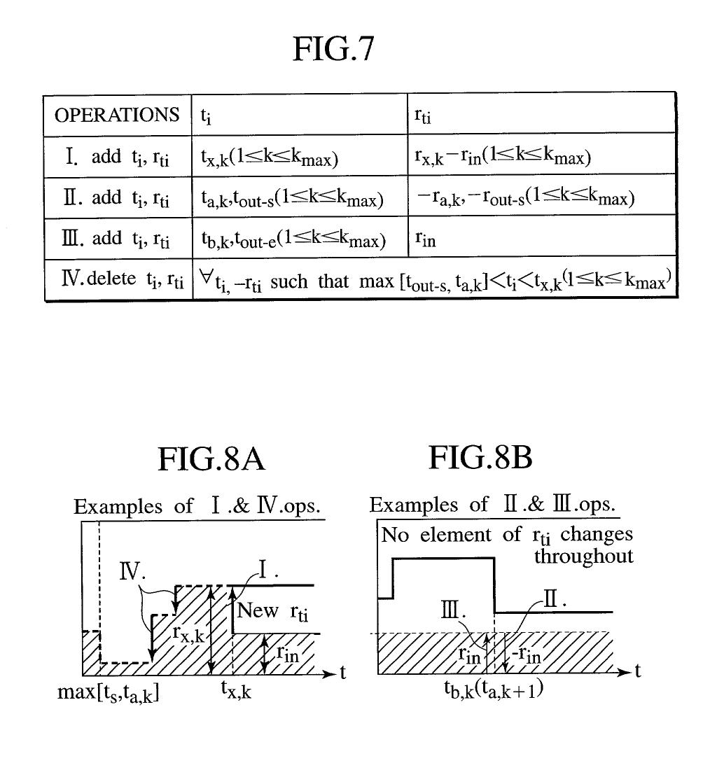

Next, the update of rφ(t) and bφ(t) when the reservation request is accepted at the ingress node will be described the update of rφ(t) can be realized by carrying out the four operations shown in FIG. 7 with respect to the series {ti} and {rt i}. FIGS. 8A and 8B show exemplary results of the four operations shown in FIG. 7. The update of bφ(t) can be realized more simply by replacing values of {bt i} (given by {bt i}, t≦ti≦tout−e) by bt i−nb(ti).

<Method for Notifying the Reservation Request From the Ingress Node to a Next Hop Node>

Here, the case of introducing the approximate functions will be described.

As described above, rrsv(t) obtained from rφ(t) and rin(t) is the bandwidth of the scheduled output rate from the ingress node, and this also indicates the scheduled input bandwidth at the next hop node on the file transfer route. Therefore, the next hop node (the core node 13 or the egress node 14) uses the rrsv(t) obtained at the previous hop node as a time function indicating the input rate in the calculation of rrsv(t) and the CAC test.

Here, rrsv(t) to be notified from the ingress node to the next hop node is given by rφ(t) and rin(t) as indicated by the equation (7), and rφ(t) may take a complicated form depending on tx. For this reason, rrsv(t) calculated at the ingress node can be approximated by simpler functions, that is shorter series in the case of expressing them in terms of series, such that the notification to the next hop node can be made easier.

In this embodiment, rrsv(t) obtained at the ingress node is approximated by two approximate functions rΛ(t) and rY(t). Here, rΛ(t) and rY(t) are selected such that the following condition is satisfied.

IrΛ(t)≦Irrsv(t)≦IrY(t) (∀ts≦t≦tout−e)

Here, rΛ(t) is defined as a function for approximating an interval [tout−s, tx) by two fixed rates rλ1 and rλ2, where a border between rλ1 and rλ2 is at a time tλ. Also, rY(t) is defined as a function for approximating an interval before tu by a fixed rate ru. Thus these two approximate functions can be expressed as follows.

$${r}_{Λ} ( t ) = \{ \begin{matrix}{r}_{λ1} , & {t}_{out - s} ≦ t < {t}_{λ} \\ {r}_{λ2} , & {t}_{λ} ≦ t < {t}_{x} \\ {r}_{i n} , & {t}_{x} ≦ t < {t}_{out - e}\end{matrix} \\ {r}_{Y} ( t ) = \{ \begin{matrix} {r}_{υ} , & {t}_{out - s} ≦ t < {t}_{υ} \\ {r}_{i n} , & {t}_{υ} ≦ t < {t}_{e}\end{matrix} \qquad ( 11 )$$

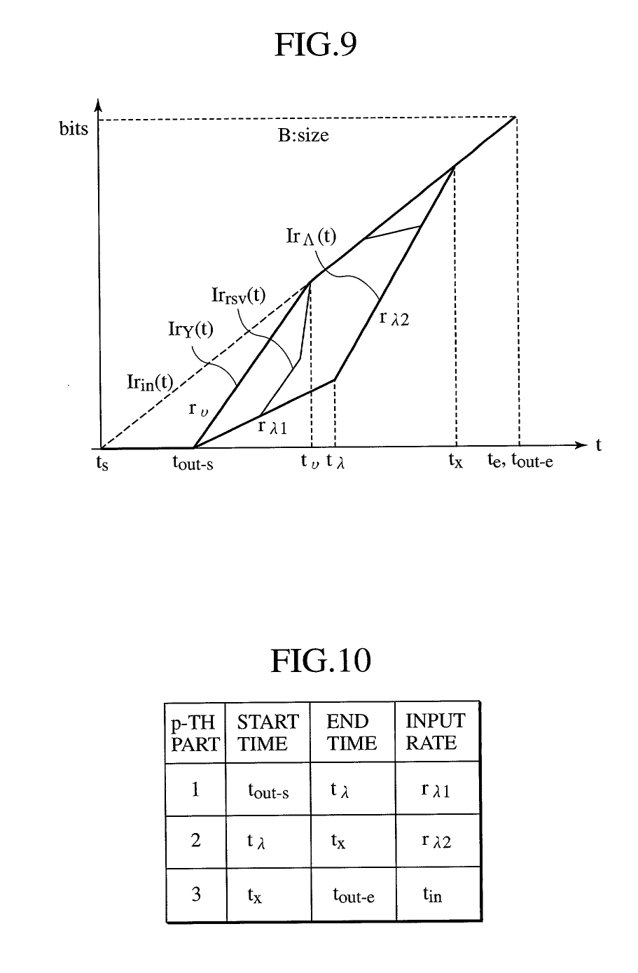

FIG. 9 shows examples of IrΛ(t) and IrY(t). As shown in FIG. 9, rΛ(t) approximates rrsv(t) in the interval from tout−s to tx by two fixed rates rλ1 and rλ2, which are selected such that the integrated value of the output data starting from tout−s is always less than or equal to rrsv (t). In the example shown in FIG. 9, rλ1, rλ2, and tλ are determined as follows.

$$\begin{matrix}{r}_{λ1} = {min}_{k > 1} [ {r}_{out - s} , {Ir}_{rsv} ( {t}_{nbmax , k} ) / ( {t}_{nbmax , k} - {t}_{out - s} ) ] \\ {t}_{λ} = {max}_{k} [ \frac{{r}_{x , k} {t}_{x , k} - {Ir}_{rsv} ( {t}_{x} ) - {r}_{λ1} {t}_{out - s}}{{r}_{x , k} - {r}_{λ1}} ] \\ {r}_{λ2} = \frac{{Ir}_{rsv} ( {t}_{x} ) - {r}_{λ1} ( {t}_{λ} - {t}_{out - s} )}{{t}_{x} - {t}_{λ}}\end{matrix} \qquad ( 12 )$$

On the other hand, rY(t) approximates an interval from tout−s to tu by one fixed rate ru (and rin is used between tu and tx). As shown in FIG. 9, ru is selected such that the integrated value of the output data is always greater than or equal to the rrsv (t) in the interval between tout−s and tx. In the example shown in FIG. 9, ru and tu are determined as follows.

$$\begin{matrix}{r}_{υ} = {max}_{k} [ \frac{{Ir}_{rsv} ( {t}_{x , k} )}{{t}_{x , k} - {t}_{out - s}} ] \\ {t}_{υ} = min [ \frac{{r}_{υ} {t}_{out - e} - {r}_{i n} {t}_{i n}}{{r}_{υ} - {r}_{i n}} , \frac{B}{{r}_{υ}} + {t}_{out - s} ]\end{matrix} \qquad ( 13 )$$

Thus rrsv(t) can possibly be a complicated function, so that, rather than notifying this function as it is to the next hop core/egress node 13/14, this function is always approximated by two approximate functions rΛ(t) and rY(t), and five parameters for specifying these two approximate functions are notified instead of rrsv(t). Hence, there are altogether eleven parameters to be notified to the next hop node, including five parameters of the approximate functions, {tx, tout−s, tout−e}, and three parameters {rin, ts, te} for specifying rin(t) that are notified from the sender as the reservation request.

<Method for Determining rrsv(t) at the Core/Egress Node>

When it is judged that the reservation request for the file transfer is acceptable at the ingress node or the core node, the next hop core/egress node 13/14 on the file transfer route receives the reservation request from the previous hop node. In the case of using approximation, the reservation request is given in terms of two functions rΛ(t) and rY(t) that are approximating the scheduled output bandwidth rrsv(t) of the previous hop node. These two functions approximate the output rate in the interval up to tx by one or two fixed rates, and these approximating fixed rates are notified to the next hop node as parameters.

The method for determining rrsv(t) at the core/egress node 13/14 is different from that at the ingress node in that rΛ(t) that is sent from the previous hop node is used instead of rin(t) in calculating rrsv(t). This rΛ(t) approximates rrsv(t) in the interval between tout−s and t, by one or two fixed rates. In the interval between tx and tout−e, rΛ(t)=rrsv(t)=rin, so that rΛ(t) can express the entire interval between tout−s and tout−e by three or less fixed rates.

For this reason, at the core/egress node 13/14, these different fixed rates are regarded as separate input blocks, and rrsv(t) is calculated for each block separately. In each block, the input rate is constant so that it can be handled similarly as rin(t) at the ingress node 12 by using the method for determining rin(t) at the ingress node 12. FIG. 10 shows the input start and end times ts and te and the input rate rin for the three blocks.

Here, by denoting values and functions for each block (1, 2, 3) by using the suffix p (1≦p≦3), rin,p(t) obtained by the method for determining rin(t) at the ingress node 12 from the elements shown in FIG. 10 is used as an input function in determining a time function rrsv,p(t) of the output bandwidth for each block. The entire rrsv(t) can be expressed as a sum of rrsv,p(t) for these blocks, that is rrsv(t)=Σsc p rrsv, p(t). Here, tout−s and tx for the entire rrsv(t) are set to be tout−s=tout−s, 1 and tx=tx, 3.

<CAC Method at the Core/Egress Node>

The CAC method at the core/egress node 13/14 is similar as that at the ingress node 12 described above, except that rrsv(t) is obtained by using the approximate function rΛ(t) instead of rin(t). The actual input data amount at the core/egress node 13/14 is always greater than or equal to IrΛ(t) so that rΛ(t) cannot be used directly in the CAC test. For this reason, rY(t) is used in the CAC test because IrY(t) is always greater than or equal to the actual input data amount so that the buffer overflow cannot be caused at each node by the flow for which the reservation request is accepted by the CAC test. In the CAC test at the core/egress node 13/14, instead of the equation (10) using in the CAC test at the ingress node 12, the following inequality (14) is used.

bt i−{IrY(ti)−IrΛ(ti)}−nb(ti)≦0 (14)

For the reservation request that is accepted by the CAC test, rφ(t) and bφ(t) are updated, by updating values of the series {ti}, {rt i} and {bt i} similarly as in the case of the ingress node 12.

<Method for Notifying the Reservation Request From the Core Node to a Next Hop Node>

Similarly as in the case of the ingress node 12, the approximate functions can be introduced at the core node 13.

For the reservation request that is accepted by the CAC test, two approximate functions rΛ(t) and rY(t) are obtained from rrsv(t) similarly as in the case of the ingress node 12. These two approximate functions are expressed by the equations (11) described above, but three parameters rλ1, tλ and ru are changed as follows.

$$\begin{matrix}{r}_{λ 1} = {min}_{1 ≦ p ≦ 3} [ {Ir}_{rsv} ( {t}_{λ , p} ) / ( {t}_{λ , p} - {t}_{out - s} ) ] \\ {t}_{λ} = {max}_{1 ≦ p ≦ 3} [ \frac{{r}_{λ , p} {t}_{λ , p} - {Ir}_{rsv} ( {t}_{λ , p} ) - {r}_{λ1} {t}_{out - s}}{{r}_{λ , p} - {r}_{λ 1}} ] \\ {r}_{υ} = {max}_{1 ≦ p ≦ 3} [ \frac{{Ir}_{rsv} ( {t}_{υ , p} )}{{t}_{υ , p} - {t}_{out - s}} ]\end{matrix} \qquad ( 15 )$$

The other parameters rλ2 and tu are the same as expressed by the equations (12) and (13). Then, eleven parameters including five parameters for specifying rΛ(t) and rY(t) so obtained are transferred to a next hop node on the transfer route.

<CAC Sequence>

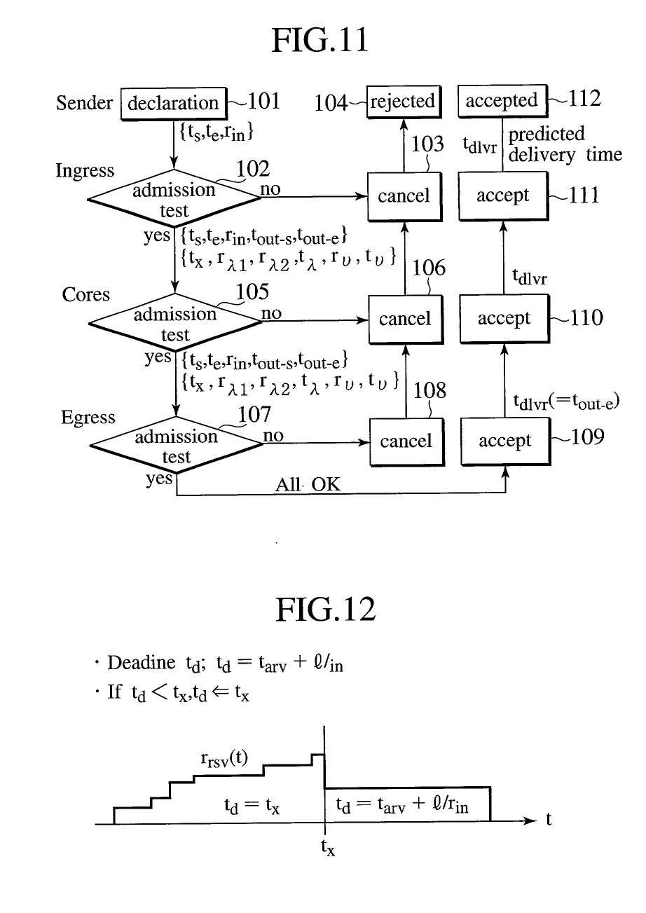

FIG. 11 shows a CAC sequence to be carried out sequentially between the ingress node 12 and the egress node 14.

As described above, when the sender 11 makes the declaration (step 101), the reservation request for the file transfer from the sender is expressed as an input function rin(t) at the ingress node 12. The ingress node 12 obtains a time function rrsv(t) for expressing the output bandwidth from rin(t), and judges whether it is possible to accept the reservation request or not according to a difference with respect to rin(t), i.e., the buffer capacity required at the ingress node 12 (by the CAC test using the equation (10) (step 102). For the reservation request that is judged as acceptable by the CAC test, two approximate functions rΛ(t) and rY(t) are obtained and parameters for specifying them are notified to a next hop node along with parameters for specifying the rin(t) at the ingress node 12 and a value of tx.

At the core/egress node 13/14 which received the notification from the ingress node 12, rrsv(t) is obtained from the approximate functions, the CAC test is carried out for it (step 105/107). Then, if the reservation request is acceptable, acceptable by the CAC test, two approximate functions rΛ(t) and rY(t) are obtained and parameters for specifying them are notified to a next hop node. This operation is repeated until the reservation request reaches to the egress node 14. For the reservation request that is accepted eventually by the CAC test at the egress node 14, the final acceptance notice is sent from the egress node 14 to the sender 11 (steps 109, 110, 111, 112). At this point, tout−e of rrsv(t) obtained at the egress node 14 is notified to the sender 11 as the predicted delivery time (predicted file transfer completion time) of the file data.

For the reservation request that is judged as not acceptable by the CAC test at any node on the transfer route, the rejection notice is returned from that node to the sender 11 and the reservation made between the ingress node 12 and that node are cancelled. (steps 103/106/108 and 104).

Next, the packet scheduling scheme in this embodiment will be described.

FIG. 12 shows the time function rrsv(t) of the output bandwidth at each node that is reserved by the resource reservation scheme described above.

In the conventional packet scheduling scheme, a deadline obtained from a constant packet output rate is set in each packet. Each node selects a packet having the closest deadline as the highest priority packet, and transmits it. By repeating this operation, the packet output rate can be adjusted to the reserved bandwidth, but it has been impossible to adjust the packet output rate in accordance with a varying reserved bandwidth.

In this embodiment, rather than changing the setting of a deadline in each packet according to a varying reserved bandwidth, the deadline is set at a time at which the varying of the reserved bandwidth stops. More specifically, the deadline of each packet is set at tx obtained above, and the packet output rate is changed in accordance with the varying reserved bandwidth. As shown in FIG. 12, tx is a time at which the data arrived and stored in the buffer becomes zero at each node, which is also a time at which the input rate and the output rate becomes equal as the entered packets are outputted without being stored in the buffer.

Here, the deadline td to be set in each packet is given by the following equation (16):

td=max[tarv+l/rin, tx] (16)

where tarv is a time at which this packet has arrived at the node, l is a packet length, and rin is a transmission rate with respect to the network (ingress node) for the file transfer that is declared by the sender 11. As indicated by the equation (16), the deadline td is a larger one of a value determined according to rin, i.e., tarv+l/rin, and tx. In this way, the deadlines of all packets that arrive during a time zone in which the reserved bandwidth is varying will be shifted to tx. Before tx, packets are outputted from the node by utilizing the vacant bandwidth. Thus, by shifting the deadlines of packets in this time zone to tx, packets will be outputted by utilizing the vacant bandwidth that is varying in time, so that the packet output rate is automatically changed in accordance with the varying reserved bandwidth.

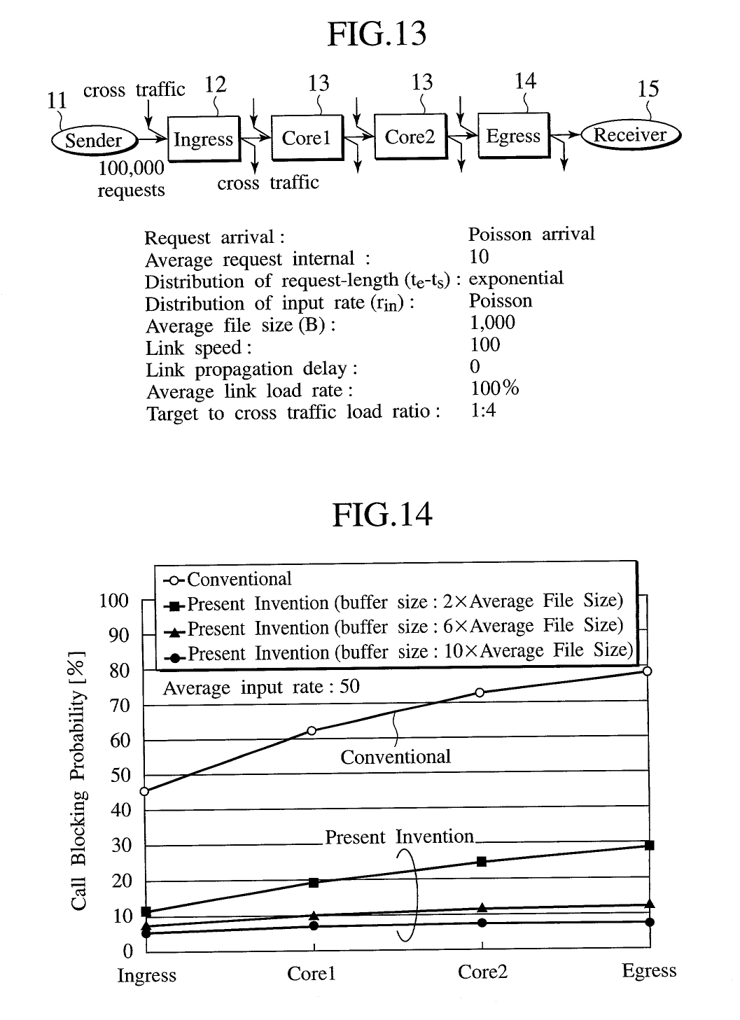

Now, the computer simulation for confirming the effects of the above described resource reservation scheme will be described. FIG. 13 shows a simulation model, which is known as a tandem type in which the target traffic is the file transfer from the sender 11 to the receiver 15 through the ingress node 12, two core nodes 13 and the egress node 14, and a cross traffic passing through each node is added.

In this simulation of the resource reservation scheme, 100,000 reservation requests for the file transfer from the sender 11 were used. It was assumed that the arrival of the reservation requests for the file transfer to the ingress node 12 is expressed by the Poisson arrival, and the average request interval is 10. It was also assumed that the distribution of request length between the start time ts and the end time te of the file transfer is the exponential distribution, and the distribution of the file data input rate rin at the ingress node 12 is the Poisson distribution. It was also assumed that the average file size is 1000, and the like between nodes has the link speed of 100 and the link propagation delay of 0. As the reservation requests for the file transfer of the average file size 1000 arrive at the average request interval of 10, the average link load rate is 100%. It was also assumed that the target to cross traffic load ratio among the link loads at each node is 1:4.

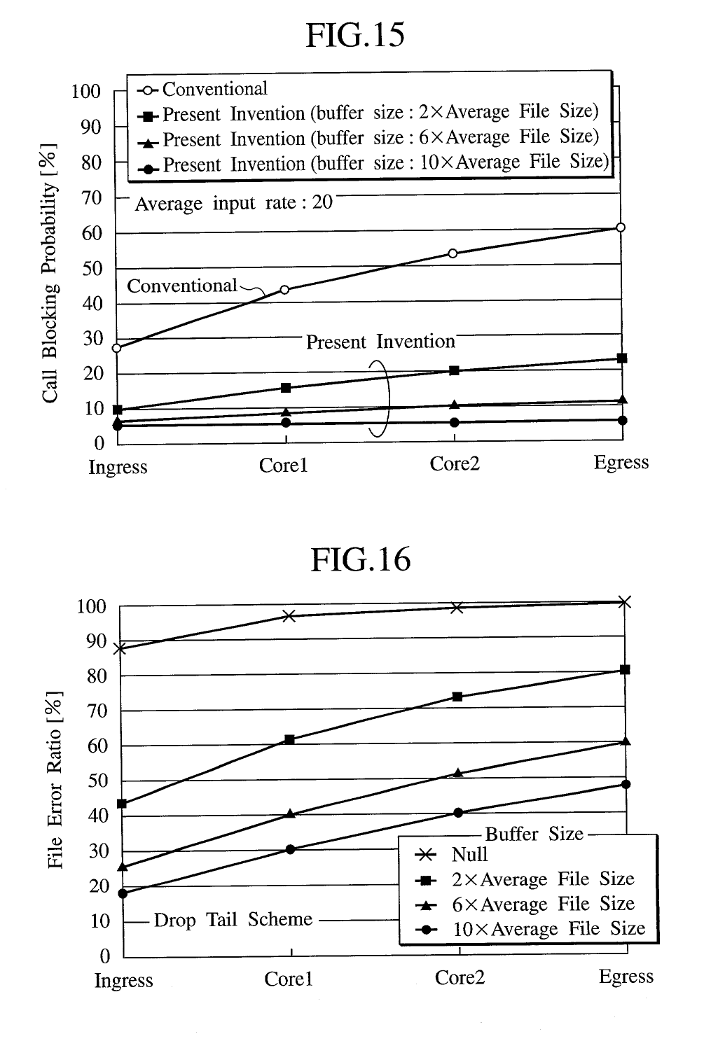

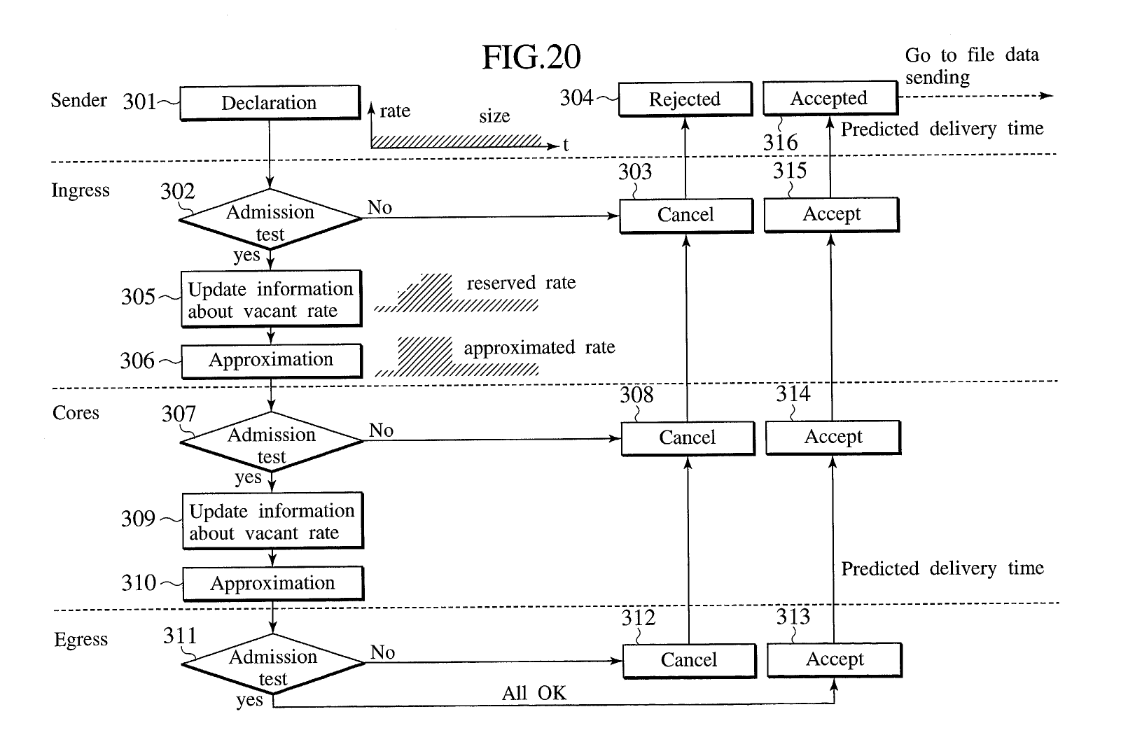

FIG. 14 and FIG. 15 show the simulation results obtained by the simulation model of FIG. 13, in terms of the call blocking probability, i.e., the ratio by which the reservation requests for the file transfer are rejected. A difference between the case shown in FIG. 14 and the case shown in FIG. 15 is the average value of rin which is set to be 50 in FIGS. 14 and 20 in FIG. 15. The case shown in FIG. 14 is the case of handling reservation requests for more bursty file transfers compared with the case shown in FIG. 15.

In FIG. 14 and FIG. 15, the “Conventional” indicates the conventional resource reservation scheme that reserves a constant bandwidth such as RSVP. Despite of the load rate of 100%, both FIG. 14 and FIG. 15 indicate that the resource reservation scheme of the present invention can improve the call blocking probability considerably compared with the conventional resource reservation scheme. Also, from the comparison of FIG. 14 and FIG. 15, it can be seen that there is a tendency for the call blocking probability to become less dependent on the burstiness of the file transfers when the larger buffer size is used at each node. In the case where the buffer size is ten times the average file size, the call blocking probability can be improved for 60% or more regardless of the burstiness.

FIG. 16 shows the file error ratio in the case of using the Drop Tail scheme which is simulated under the same conditions as the case shown in FIG. 14. In this simulation, the resource reservation for the file transfer is not made, so that when the traffics are congested and the buffer overflow occurs, a part of a whole of the file data will be lost due to the packet loss. From the comparison with the call blocking probability of FIG. 14, it can be seen that apparently more files have the lost data due to the packet loss even when the same amount of buffers are used at each node.

Thus the resource reservation scheme of this embodiment can improve the multiplexing efficiency of the file transfer compared with the conventional resource reservation scheme, and improve the call blocking probability considerably. Moreover, it is possible to reduce the file error (data loss due to packet loss) ratio considerably compared with the case of the file transfer using the same buffer capacity at each node without the resource reservation.

Next, the computer simulation for confirming the effects of the above described packet scheduling scheme will be described. The same simulation model as shown in FIG. 13 was used and the same conditions as in the case of FIG. 14 were used.

In this simulation of the packet scheduling scheme, 10,000 file transfers from the sender 11 were used. It was assumed that the packet length is 100 in every file transfer except for the last packet.

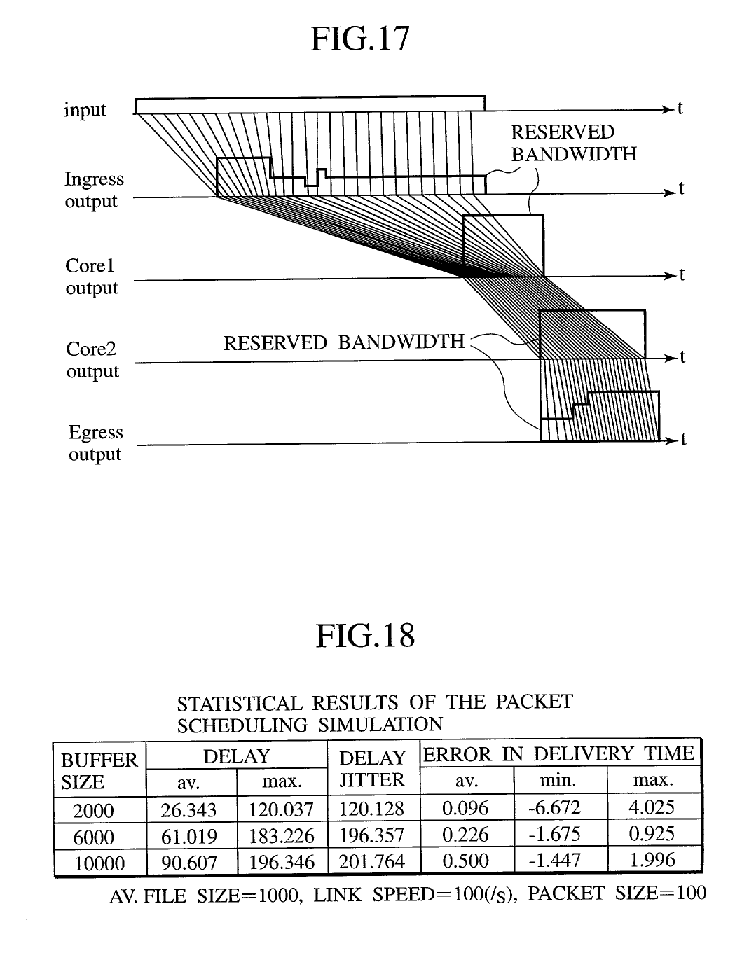

FIG. 17 shows the packet scheduling simulation result in which the bandwidths (bold lines) reserved by the resource reservation scheme and the trajectories (thin lines) of packets transferred according to these bandwidths. Unlike the conventional scheme such as RSVP, the output bandwidth reserved at each node is varying according to the vacant bandwidth state at a time of the reservation as indicated by the bold lines. The trajectories of packets indicated by the thin lines show that the packet output rate from each node is changed in accordance with the reserved bandwidth that is varying in time.

At FIG. 18 shows the packet scheduling simulation result in forms of statistical data. FIG. 18 indicates that the delay and the delay jitter are increased as the buffer size at each node is increased, which implies that the packet scheduling scheme of this embodiment improves the call blocking probability by sacrificing the delay and the delay jitter. IN FIG. 18, the “error in delivery time” indicates an error of the predicted file transfer completion time with respect to the actual output time of the last packet. In each case, the average error is within one packet time, which indicates that the packet scheduling is carried out in accordance with the varying reserved bandwidth accurately.

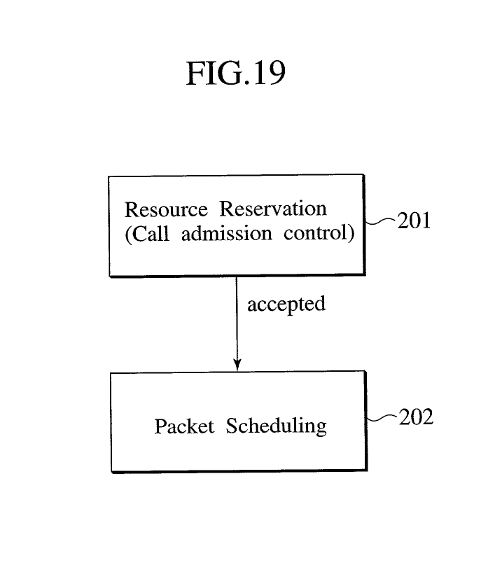

Now, with references to FIG. 19 to FIG. 27, the operations in the resource reservation scheme and the packet scheduling scheme according to this embodiment will be summarized.

As shown in FIG. 19, in this embodiment, the resource reservation (call admission control) is carried out first (step 201) and then the packet scheduling is carried out (step 202).

In the resource reservation, the call admission control is carried out as shown in FIG. 20.

Namely, the sender 11 declares the input rate (step 301), and the ingress node 12 carries out the CAC test (step 302). If the reservation request is rejected, the reservation is cancelled (step 303) and the rejection notice is sent to the sender 11 (step 304). On the other hand, if the reservation request is accepted, the information about the vacant rate is updated (step 305), and the approximation is carried out (step 306).

Then, the core node 13 carries out the CAC test (step 307). If the reservation request is rejected, the reservation is cancelled (steps 303, 308) and the rejection notice is sent to the sender 11 (step 304). On the other hand, if the reservation request is accepted, the information about vacant rate is updated (step 309), and the approximation is carried out (step 310).

Then, the egress node 14 carries out the CAC test (step 311). If the reservation request is rejected, the reservation is cancelled (steps 303, 308, 312) and the rejection notice is sent to the sender 11 (step 304). On the other hand, if the reservation request is accepted, the acceptance notice is sent to the sender 11 (steps 313, 314, 315 and 316).

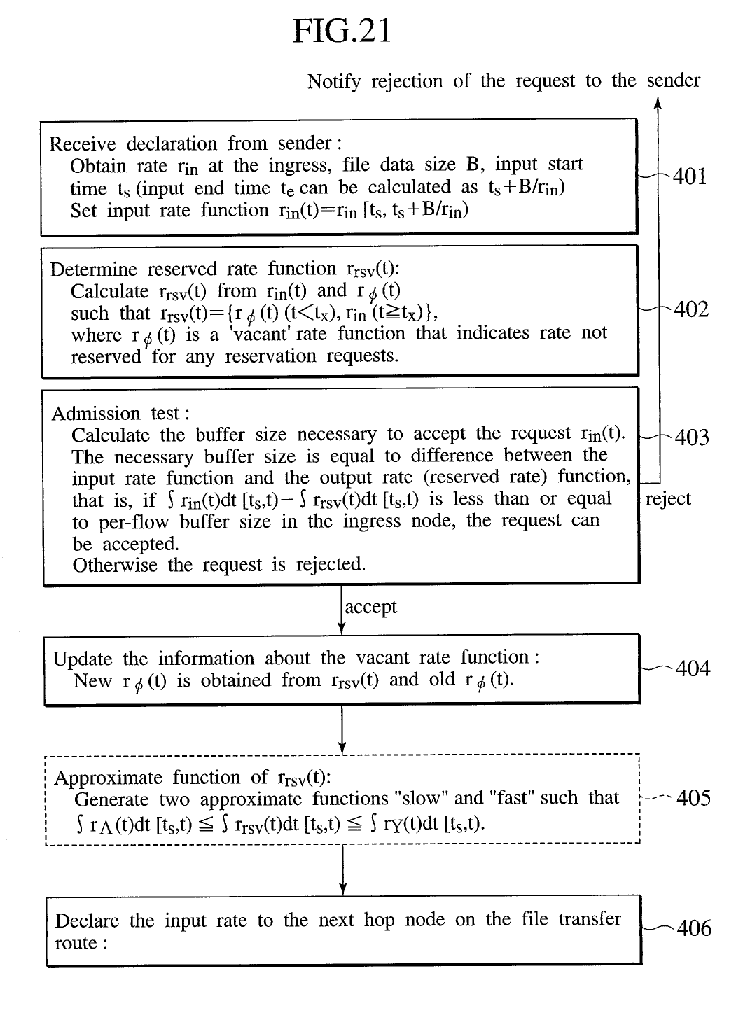

In the resource reservation, the operation of the ingress node 12 is as shown in FIG. 21.

Namely, the ingress node 12 first receives the declaration from the sender, obtains the input rate rin, the file data size B and the input start time ts (where the input end time te can be calculated as ts+B/rin, and sets the input rate function rin(t)=rin[ts, ts+B/rin) (step 401).

Then, the ingress node 12 determines the reserved rate function rrsv(t) by calculating rrsv(t) from rin(t) and rφ(t) such that rrsv(t)={rφ(t) (t<tx), rin(t≧tx), where rφ(t) is a vacant rate function that indicates a rate not reserved for any reservation requests (step S402).

Then, the ingress node 12 carries out the CAC test by calculating the buffer size necessary to accept the request rin(t) (step 403). Here, the necessary buffer size is equal to a difference between the input rate function and the output rate (reserved rate) function, that is if ∫rin(t)dt[ts,t) −∫rrsv(t)dt[ts,t) is less than or equal to the per-flow buffer size in the ingress node 12, the reservation request can be accepted. Otherwise, the reservation request is rejected and the rejection of the request is notified to the sender 11.

When the reservation request is accepted, the ingress node 12 updates the information about the vacant rate function by obtaining the new rφ(t) from rrsv(t) and the old rφ(t) (step 404).

Then, the ingress node 12 generates two approximate functions “slow” and “fast” such that ∫rΛ(t)dt[ts,t)≦∫rsrv(t)dt[ts,t)≦∫rY(t)dt[ts,t) (step 405).

Then, the ingress node 12 declares the input rate to the next hop node on the file transfer route (step 406).

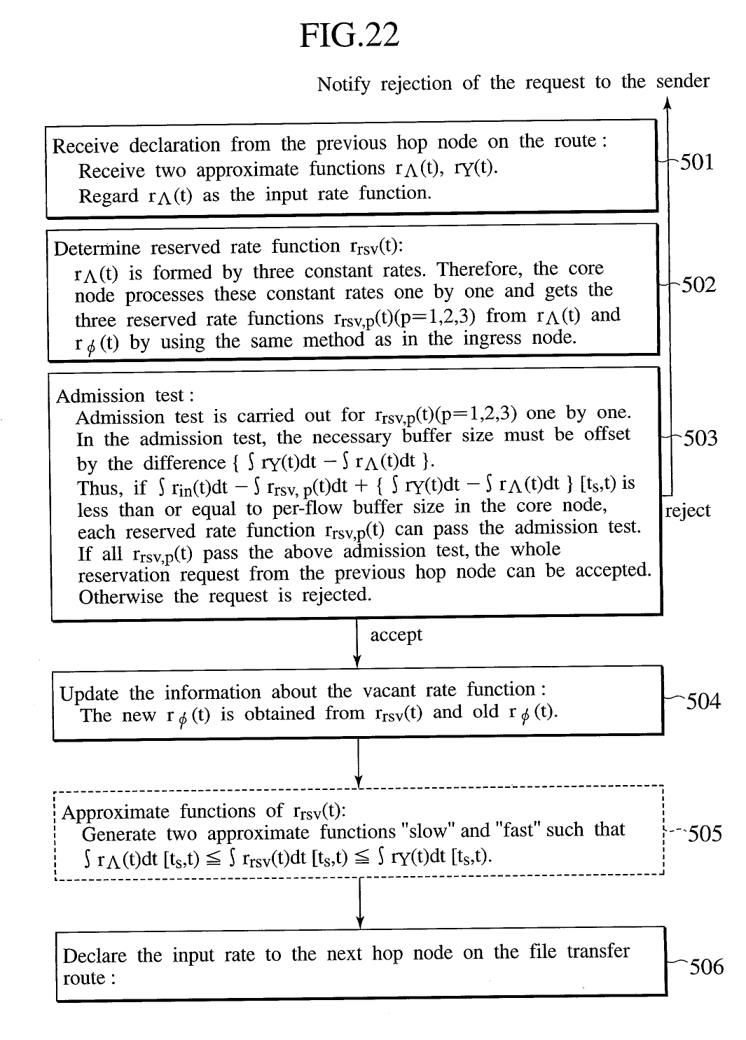

Also, in the resource reservation, the operation of the core node 13 is as shown in FIG. 22.

Namely, the core node 13 first receives the declaration from the previous hop node on the file transfer route, receives two approximate functions rΛ(t) and rY(t), and regards rΛ(t) as the input rate function (step 501).

Then, the core node 13 determines the reserved rate function rrsv(t) (step 502). Here, rΛ(t) is formed by three constant rates, so that the core node 13 processes these constant rates one by one and gets the three reserved rate functions rrsv1(t) to rrsv3(t) from rΛ(t) and rφ(t) by using the same method as in the ingress node 12.

Then, the core node 13 carries out the CAC test for rrsv, p(t) (p=1, 2, 3) one by one (step 503). In the CAC test, the necessary buffer size must be offset by the difference {∫rY(t)dt−∫rΛ(t)dt}. Thus ∫rin(t)dt−∫rsv, p(t)dt+{∫rY(t)dt−∫rΛ(t)dt}[ts,t) is less than or equal to the per-flow buffer size in the core node 13, each reserved rate function rrsv, p(t) can pass the CAC test. If all rrv, p(t) pass the CAC test, the whole reservation request from the previous hop node can be accepted. Otherwise, the reservation request is rejected and the rejection of the request is notified to the sender 11.

When the reservation request is accepted, the core node 13 updates the information about the vacant rate function by obtaining the new rφ(t) from rrsv(t) and the old rφ(t) (step 504).

Then, the core node 13 generates two approximate functions “slow” and “fast” such that ∫rΛ(t)dt[ts,t)≦∫rrsv(t)dt[ts, t)≦∫rY(t)dt[ts, t) (step 505).

Then, the core node 13 declares the input rate to the next hop node on the file transfer route (step 506).

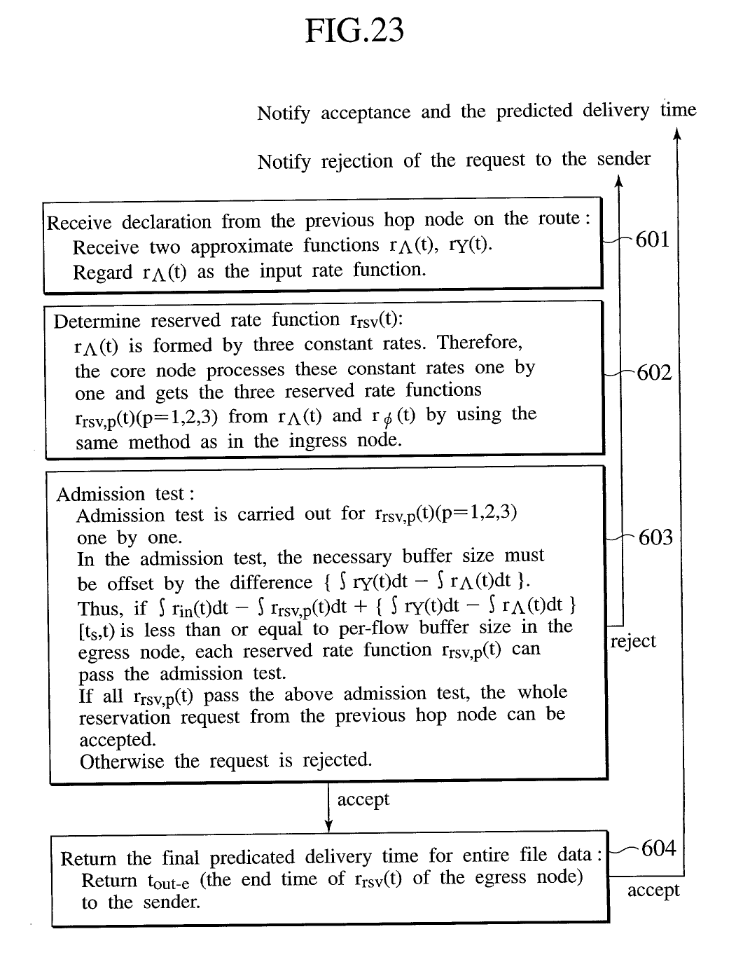

Also, in the resource reservation, the operation of the egress node 14 is as shown in FIG. 23.

Namely, the egress node 14 first receives the declaration from the previous hop node on the file transfer route, receives two approximate functions rΛ(t) and rY(t), and regards rΛ(t) as the input rate function (step 601).

Then, the egress node 14 determines the reserved rate function rrsv(t) (step 602). Here, rΛ(t) is formed by three constant rates, so that the core node 13 processes these constant rates one by one and gets the three reserved rate functions rrsv1(t) to rrsv3 (t) from rΛ(t) and rφ(t) by using the same method as in the ingress node 12.

Then, the egress node 14 carries out the CAC test for rrsv, p(t) (p=1, 2, 3) one by one (step 603). In the CAC test, the necessary buffer size must be offset by the difference {∫rY(t)dt−∫rΛ(t)dt}. Thus if ∫rin(t)dt−∫rrsv, p(t)dt+{∫rY(t)dt−∫rΛ(t)dt}[ts,t) is less than or equal to the per-flow buffer size in the core node 13, each reserved rate function rrsv,p(t) can pass the CAC test. If all rrsv,p(t) pass the CAC test, the whole reservation request from the previous hop node can be accepted. Otherwise, the reservation request is rejected and the rejection of the request is notified to the sender 11.

When the reservation request is accepted, the egress node 14 returns the final predicted delivery time for the entire file data by returning tout−e(the end time of rrsv(t) of the egress node) to the sender 11, and notifies the acceptance of the reservation request (step 604).

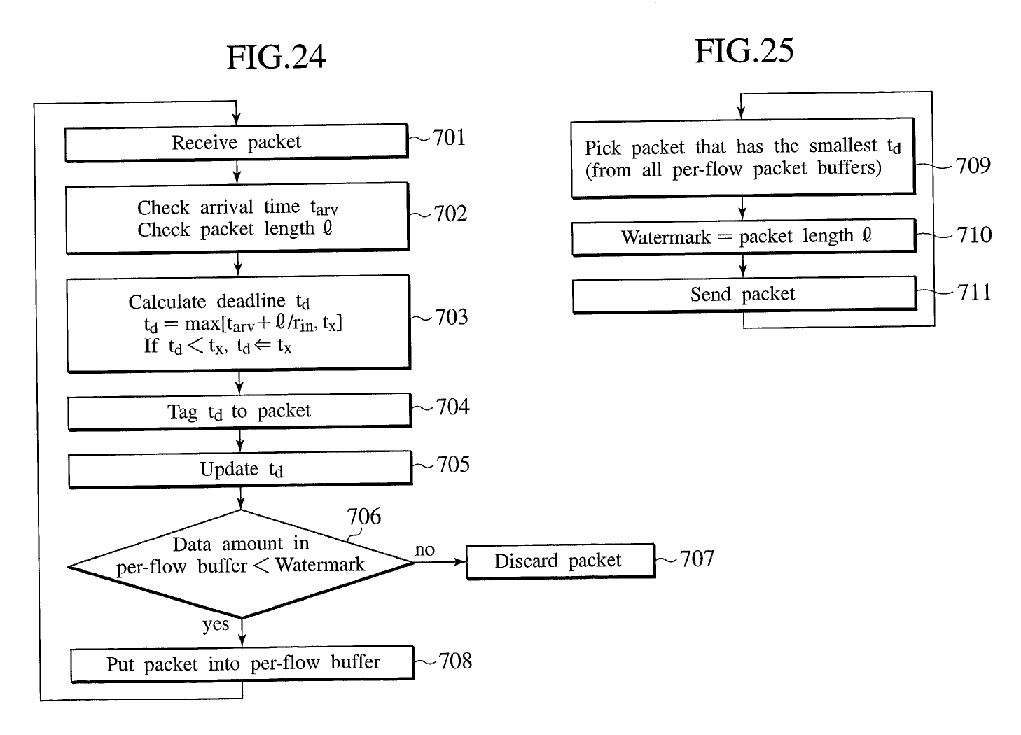

On the other hand, in the packet scheduling, the operation of the ingress node 12 is as shown in FIG. 24 and FIG. 25.

Namely, the ingress node 12 receives a packet (step 701), checks the arrival time tarv and the packet length l (step 702), and calculates the deadline td=max[tarv+l/rin, tx]. If td<tx, td is set to be tx(step 703).

Then, the ingress node 12 tags td to the packet (step 704), and updates td(step 705).

Then, if the data amount in per-flow buffer is less than the watermark (step 706 YES), the ingress node 12 puts the packet into the per-flow buffer (step 708), whereas otherwise the ingress node 12 discard the packet (step 707).

Then, the ingress node 12 picks the packet that has the smallest td from all per-flow packet buffers (step 709), sets the watermark to be the packet length l (step 710), and sends the packet (step 711).

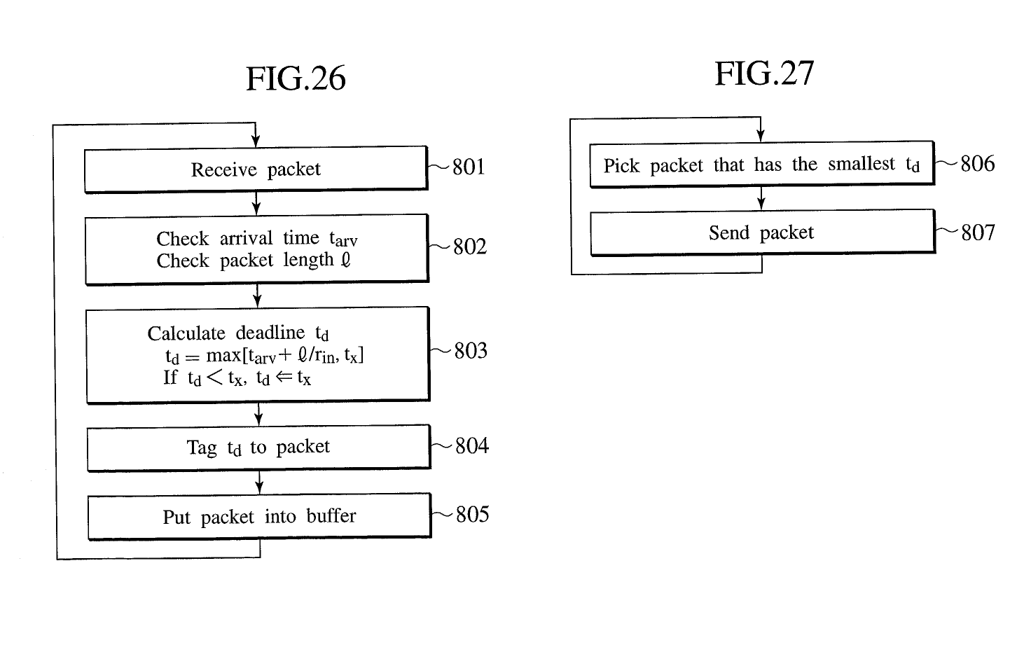

Also, in the packet scheduling, the operation of the core/egress node 13/14 is as shown in FIG. 26 and FIG. 27.

Namely, the core/egress node 13/14 receives a packet (step 801), checks the arrival time tarv and the packet length l (step 802), and calculates the deadline td=max[tarv+l/rin, tx]. If td<tx, td is set to be tx(step 803).

Then, the core/egress node 13/14 tags td to the packet (step 804), and puts the packet into the buffer (step 805).

Then, the core/egress node 13/14 picks the packet that has the smallest td(step 806), and sends the packet (step 807).

As described, according to the resource reservation scheme and the packet scheduling scheme of the present invention, the vacant bandwidth of the network which is varying in time is reserved, the predicted file transfer completion time is obtained at a time of the reservation, and the actual packet output rate at each node is changed in accordance with the reserved bandwidth that is varying in time, so that it is possible to improve the multiplexing efficiency of the file transfer and it is possible to guarantee the completion of the file transfer by the predicted file transfer completion time.

It is to be noted that the above described embodiment according to the present invention may be conveniently implemented using a conventional general purpose digital computer programmed according to the teachings of the present specification, as will be apparent to those skilled in the computer art. Appropriate software coding can readily be prepared by skilled programmers based on the teachings of the present disclosure, as will be apparent to those skilled in the software art.

In particular, each node of the above described embodiment can be conveniently implemented in a form of a software package.

Such a software package can be a computer program product which employs a storage medium including stored computer code which is used to program a computer to perform the disclosed function and process of the present invention. The storage medium may include, but is not ,: limited to, any type of conventional floppy disks, optical disks, CD-ROMS, magneto-optical disks, ROMs, RAMs, EPROMs, EEPROMs, magnetic or optical cards, or any other suitable media for storing electronic instructions.

It is also to be noted that, besides those already mentioned above, many modifications and variations of the above embodiment may be made without departing from the novel and advantageous features of the present invention. Accordingly, all such modifications and variations are intended to be included within the scope of the appended claims.

What is claimed is:

1. A method of resource reservation for a file transfer at an ingress node, core nodes, and an egress node on a file transfer route in a packet switching network, comprising the steps of:
(a) receiving a reservation request for the file transfer from a sender or a receiver at the ingress node;
(b) sequentially carrying out a control processing at each node among the ingress node, the core nodes and the egress node, the control processing being a processing for determining a reserved rate function rrsv(t) indicating an output bandwidth at each node as a function of time t according to an input rate function rin(t) indicating an input bandwidth at each node as a function of time t and a vacant rate function rφ(t) indicating a vacant bandwidth at each node as a function of time t, and judging whether it is possible to accept the reservation request at each node or not according to whether a difference between the input rate function and the output rate function exceeds a buffer capacity available at each node or not;
(c) sequentially transferring the reservation request from each node among the ingress node and the core nodes to a next hop node on the file transfer route when it is possible to accept the reservation request at each node, or rejecting the reservation request when it is not possible to accept the reservation request at each node;
(d) accepting the reservation request when the egress node judges that it is possible to accept the reservation request, or rejecting the reservation request otherwise; and
(e) reserving the output bandwidth at each node among the ingress node, the core nodes and the egress node as indicated by the reserved rate function rrsv(t) of each node when the reservation request is accepted.

2. The method of claim 1, wherein at the step (a), the ingress node receives the reservation request indicating a file size B of a file to be transferred, an input rate rin by which the file is to be transmitted from the sender to the packet switching network, and a time ts at which input of file data from the sender to the packet switching network starts, and sets the input rate function rin(t) of the ingress node as rin(t)=rin[ts, ts+B/rin).

3. The method of claim 1, wherein at the step (b), each node carries out the control processing by obtaining a time tx at which an input data amount and an output data amount at each node coincide according to the input rate function rin(t) and the vacant rate function rφ(t), and setting the reserved rate function rrsv(t) at each node as rrsv(t)=rφ(t) (ts≦t<tx), rrsv(t)=rin(t) (t≧tx), where ts is a time at which input of file data from the sender to the packet switching network starts.

4. The method of claim 1, wherein at the step (b), each node carries out the control processing by judging whether ∫rin(t)dt[ts, t)−∫rrsv(t)dt[ts, t) exceeds the buffer capacity available at each node or not, where ts is a time at which input of file data from the sender to the packet switching network starts.

5. The method of claim 1, wherein when any one node among the ingress node and the core nodes judges that it is possible to accept the reservation request at the step (b), said any one node transfers the reservation request to the next hop node at the step (c) by indicating the input rate function rin(t) of the next hop node according to the reserved rate function rrsv(t) of said any one node.

6. The method of claim 5, wherein at the step (c), said any one node indicates the reserved rate function rrsv(t) of said any one node as the input rate function rin(t) of the next hop node.

7. The method of claim 5, wherein at the step (c), said any one node generates two approximate functions rΛ(t) and rY(t) for approximating the reserved rate function rrsv(t) of said any one node such that ∫rΛ(t)dt≦∫frrsv(t)dt≦∫rY(t)dt (∀t), and indicates rΛ(t) as the input rate function rin(t) of the next hop node.

8. The method of claim 7, wherein at the step (b), each node among the core nodes and the egress node carries out the control processing by judging whether ∫rin(t)dt[ts, t)−∫rrsv(t)dt[ts, t)+{∫rΛ(t)dt−∫rY(t)dt}[ts, t) exceeds the buffer capacity available at each node or not, where ts is a time at which input of file data from the sender to the packet switching network starts.

9. The method of claim 1, wherein when the reservation request is accepted at the step (d), the egress node notifies an acceptance of the reservation request to the sender or the receiver along with a predicted file transfer completion time.

10. A method of packet scheduling in a packet switching network for transferring packets of a file from a sender to a receiver, through an ingress node, core nodes, and an egress node on a file transfer route, comprising the steps of:
setting a deadline td for transmitting each packet at each node on a file transfer route, as td=max[tarv+l/rin, tx], where tarv is an arrival time of each packet at each node, l is a packet length, rin is an input rate by which the file is to be transmitted from the sender to the packet switching network, and tx is a time at which an input data amount and an output data amount at each node coincide; and
selecting one packet among packets buffered in each node which has the deadline td that is smallest among the packets buffered in each node, and transmitting said one packet from each node.

11. A packet switching network system formed by a plurality of nodes, for carrying out a resource reservation for a file transfer at an ingress node, core nodes, and an egress node on a file transfer route, wherein;
the ingress node has a unit configured to receive a reservation request for the file transfer from a sender or a receiver;
each one of the ingress node, the core nodes and the egress node has a unit configured to carry out a control processing for determining a reserved rate function rrsv(t) indicating an output bandwidth at each node as a function of time t according to an input rate function rin(t) indicating an input bandwidth at each node as a function of time t and a vacant rate function rφ(t) indicating a vacant bandwidth at each node as a function of time t, and judging whether it is possible to accept the reservation request at each node or not according to whether a difference between the input rate function and the output rate function exceeds a buffer capacity available at each node or not;
each one of the ingress node and the core nodes has a unit configured to transfer the reservation request to a next hop node on the file transfer route when it is possible to accept the reservation request at each node, or reject the reservation request when it is not possible to accept the reservation request at each node, such that the reservation request is sequentially transferred from the ingress node through the core nodes to the egress node while the control processing is sequentially carried out at each node among the ingress node, the core nodes and the egress node;
the egress node has a unit configured to accept the reservation request when the egress node judges that it is possible to accept the reservation request, or reject the reservation request otherwise; and
each one of the ingress node, the core nodes and the egress node has a unit configured to reserve the output bandwidth at each node as indicated by the reserved rate function rrsv(t) of each node when the reservation request is accepted.

12. The system of claim 11, wherein the ingress node receives the reservation request indicating a file size B of a file to be transferred, an input rate rin by which the file is to be transmitted from the sender to the packet switching network, and a time ts at which input of file data from the sender to the packet switching network All starts, and sets the input rate function rin(t) of the ingress node as rin(t)=rin[tₛ, ts+B/rin).

13. The system of claim 11, wherein each node carries out the control processing by obtaining a time tx at which an input data amount and an output data amount at each node coincide according to the input rate function rin(t) and the vacant rate function rφ(t), and setting the reserved rate function rrsv(t) at each node as rrsv(t)=rφ(t) (ts≦t<tx), rrsv(t)=rin(t) (t≧tx), where ts is a time at which input of file data from the sender to the packet switching network starts.

14. The system of claim 11, wherein each node carries out the control processing by judging whether ∫rin(t)dt[ts, t) −∫rrsv(t)dt[ts, t) exceeds the buffer capacity available at each node or not, where ts is a time at which input of file data from the sender to the packet switching network starts.

15. The system of claim 11, wherein when any one node among the ingress node and the core nodes judges that it is possible to accept the reservation request, said any one node transfers the reservation request to the next hop node on the file transfer route by indicating the input rate function rin(t) of the next hop node according to the reserved rate function rrsv(t) of said any one node.

16. The system of claim 15, wherein said any one node indicates the reserved rate function rrsv(t) of said any one node as the input rate function rin(t) of the next hop node.

17. The system of claim 15, wherein said any one node generates two approximate functions rΛ(t) and rY(t) for approximating the reserved rate function rrsv(t) of said any one node such that ∫rΛ(t)dt≦∫rrsv(t)dt≦∫rY(t)dt (∀t), and indicates rΛ(t) as the input rate function rin(t) of the next hop node.

18. The system of claim 17, wherein each node among the core nodes and the egress node carries out the control processing by judging whether ∫rin(t)dt[ts, t)−∫rrsv(t)dt[ts, t)+{∫rΛ(t)dt−∫rY(t)dt}[ts, t) exceeds the buffer capacity available at each node or not, where a time t at which input of file data from the sender to the packet switching network starts.

19. The system of claim 11, wherein when the reservation request is accepted, the egress node notifies an acceptance of the reservation request to the sender or the receiver along with a predicted file transfer completion time.

20. A packet switching network system formed by a plurality of nodes, for transferring packets of a file from a sender to a receiver, through an ingress node, core nodes, and an egress node on a file transfer route, wherein;
each node has a unit configured to set a deadline t_{d} for transmitting each packet at each node, as t_{d}=max[tarv+l/rin, tx], where tarv is an arrival time of each packet at each node, l is a packet length, rin is an input rate by which the file is to be transmitted from the sender to the packet switching network, and tx is a time at which an input data amount and an output data amount at each node coincide; and
each node has a unit configured to select one packet among packets buffered in each node which has the deadline td that is smallest among the packets buffered in each node, and transmit said one packet from each node.

21. A method of resource reservation for a file transfer at a node device which is one of an ingress node, core nodes, and an egress node on a file transfer route in a packet switching network, comprising the steps of:
(a) receiving a reservation request for the file transfer from a sender or a receiver if the node device is the ingress node;
(b) carrying out a control processing for determining a reserved rate function rrsv(t) indicating an output bandwidth at the node device as a function of time t according to an input rate function rin(t) indicating an input bandwidth at the node device as a function of time t and a vacant rate function rφ(t) indicating a vacant bandwidth at the node device as a function of time t, and judging whether it is possible to accept the reservation request at the node device or not according to whether a difference between the input rate function and the output rate function exceeds a buffer capacity available at the node device or not;
(c) transferring the reservation request to a next hop node on the file transfer route when it is possible to accept the reservation request at the node device, or rejecting the reservation request when it is not possible to accept the reservation request at the node device, if the node device is one of the ingress node and the core nodes;
(d) accepting the reservation request when it is possible to accept the reservation request, or rejecting the reservation request otherwise, if the node device is the egress node; and
(e) reserving the output bandwidth at the node device as indicated by the reserved rate function rrsv(t) of the node device when the reservation request is accepted.

22. The method of claim 21, wherein at the step (a), the node device receives the reservation request indicating a file size B of a file to be transferred, an input rate rin by which the file is to be transmitted from the sender to the packet switching network, and a time ts at which input of file data from the sender to the packet switching network starts, and sets the input rate function rin(t) of the node device as rin(t)=rin[ts, ts+B/rin).

23. The method of claim 21, wherein at the step (b), the node device carries out the control processing by obtaining a time tx at which an input data amount and an output data amount at the node device coincide according to the input rate function rin(t) and the vacant rate function rφ(t), and setting the reserved rate function rrsv(t) at the node device as rrsv(t)=rφ(t) (ts23 t<tx), rrsv(t)=rin(t) (t≧tx), where ts is a time at which input of file data from the sender to the packet switching network starts.

24. The method of claim 21, wherein at the step (b), the node device carries out the control processing by judging whether ∫rin(t)dt[ts, t)−∫rrsv(t)dt[ts, t) exceeds the buffer capacity available at the node device or not, where ts is a time at which input of file data from the sender to the packet switching network starts.

25. The method of claim 21, wherein when the node device is one of the ingress node and the core nodes and judges that it is possible to accept the reservation request at the step (b), the node device transfers the reservation request to the next hop node at the step (c) by indicating the input rate function rin(t) of the next hop node according to the reserved rate function rrsv(t) of the node device.

26. The method of claim 25, wherein at the step (c), the node device indicates the reserved rate function rrsv(t) of the node device as the input rate function rin(t) of the next hop node.

27. The method of claim 25, wherein at the step (c), the node device generates two approximate functions rΛ(t) and rY(t) for approximating the reserved rate function rrsv(t) of the node device such that ∫rΛ(t)dt≦∫rrsv(t)dt≦∫rY(t)dt (∀t), and indicates rΛ(t) as the input rate function rin(t) of the next hop node.

28. The method of claim 27, wherein when the node device is one of the core nodes and the egress node, the node device carries out the control processing at the step (b) by judging whether ∫rin(t)dt[ts, t)−∫rrsv(t)dt[ts, t)+{∫rΛ(t)dt−∫rY(t)dt}[ts, t) exceeds the buffer capacity available at the node device or not, where ts is a time at which input of file data from the sender to the packet switching network starts.

29. The method of claim 21, wherein when the reservation request is accepted at the step (d) and the node device is the egress node, the node device notifies an acceptance of the reservation request to the sender or the receiver along with a predicted file transfer completion time.

30. A method of packet scheduling in a packet switching network for transferring packets of a file from a sender to a receiver, at a node device which is one of an ingress node, core nodes, and an egress node on a file transfer route, comprising the steps of:
setting a deadline td for transmitting each packet at the node device on a file transfer route, as td=max[tarv+l/rin, tx], where tarv is an arrival time of each packet at the node device, l is a packet length, rin is an input rate by which the file is to be transmitted from the sender to the packet switching network, and tx is a time at which an input data amount and an output data amount at the node device coincide; and
selecting one packet among packets buffered in the node device which has the deadline td that is smallest among the packets buffered in the node device, and transmitting said one packet from the node device.

31. A node device for carrying out a resource reservation for a file transfer as one of an ingress node, core nodes, and an egress node on a file transfer route in a packet switching network, the node device comprising:
a first unit configured to receive a reservation request for the file transfer from a sender or a receiver if the node device is the ingress node;
a second unit configured to carry out a control processing for determining a reserved rate function rrsv(t) indicating an output bandwidth at the node device as a function of time t according to an input rate function rin(t) indicating an input bandwidth at the node device as a function of time t and a vacant rate function rφ(t) indicating a vacant bandwidth at the node device as a function of time t, and judging whether it is possible to accept the reservation request at the node device or not according to whether a difference between the input rate function and the output rate function exceeds a buffer capacity available at the node device or not;
a third unit configured to transfer the reservation request to a next hop node on the file transfer route when it is possible to accept the reservation request at the node device, or reject the reservation request when it is not possible to accept the reservation request at the node device, if the node device is one of the ingress node and the core nodes;
a fourth unit configured to accept the reservation request when it is possible to accept the reservation request, or reject the reservation request otherwise, if the node device is the egress node; and
a fifth unit configured to reserve the output bandwidth at the node device as indicated by the reserved rate function rrsv(t) of the node device when the reservation request is accepted.

32. The node device of claim 31, wherein the first unit receives the reservation request indicating a file size B of a file to be transferred, an input rate rin by which the file is to be transmitted from the sender to the packet switching network, and a time ts at which input of file data from the sender to the packet switching network starts, and sets the input rate function rin(t) of the node device as rin(t)=rin[ts, ts+B/rin).

33. The node device of claim 31, wherein the second unit carries out the control processing by obtaining a time tx at which an input data amount and an output data amount at the node device coincide according to the input rate function rin(t) and the vacant rate function rφ(t), and setting the reserved rate function rrsv(t) at the node device as rrsv(t)=rφ(t) (ts≦t<tx), rrsv(t)=rin(t) (t≧tx), where ts is a time at which input of file data from the sender to the packet switching network starts.

34. The node device of claim 31, wherein the second unit carries out the control processing by judging whether ∫rin(t)dt[ts, t)−∫rrsv(t)dt[ts, t) exceeds the buffer capacity available at the node device or not, where ts is a time at which input of file data from the sender to the packet switching network starts.

35. The node device of claim 31, wherein when the node device is one of the ingress node and the core nodes and the second unit judges that it is possible to accept the reservation request, the third unit transfers the reservation request to the next hop node at the step (c) by indicating the input rate function rin(t) of the next hop node according to the reserved rate function rrsv(t) of the node device.

36. The node device of claim 35, wherein the third unit indicates the reserved rate function rrsv(t) of the node device as the input rate function rin(t) of the next hop node.

37. The node device of claim 35, wherein the third unit generates two approximate functions rΛ(t) and rY(t) for approximating the reserved rate function rrsv(t) of the node device such that ∫rΛ(t)dt≦∫rrsv(t)dt≦∫rY(t)dt (∀t), and indicates rΛ(t) as the input rate function rin(t) of the next hop node.

38. The node device of claim 37, wherein when the node device is one of the core nodes and the egress node, the second unit carries out the control processing by judging whether ∫rin(t)dt[ts, t)−∫rrsv(t)dt[ts, t)+{∫rΛ(t)dt−∫rΛ(t)dt}[ts, t) exceeds the buffer capacity available at the node device or not, where ts is a time at which input of file data from the sender to the packet switching network starts.

39. The node device of claim 31, wherein when the reservation request is accepted and the node device is the egress node, the fourth unit notifies an acceptance of the reservation request to the sender or the receiver along with a predicted file transfer completion time.

40. A node device for carrying out a packet scheduling in a packet switching network for transferring packets of a file from a sender to a receiver, as one of an ingress node, core nodes, and an egress node on a file transfer route, the node device comprising:
a first unit configured to set a deadline td for transmitting each packet at the node device on a file transfer route, as td=max[tarv+l/rin, tx], where tarv is an arrival time of each packet at the node device, Q is a packet length, rin is an input rate by which the file is to be transmitted from the sender to the packet switching network, and tx is a time at which an input data amount and an output data amount at the node device coincide; and
a second unit configured to select one packet among packets buffered in the node device which has the deadline td that is smallest among the packets buffered in the node device, and transmit said one packet from the node device.

41. A computer usable medium having computer readable program codes embodied therein for causing a computer to function as a node device for carrying out a resource reservation for a file transfer as one of an ingress node, core nodes, and an egress node on a file transfer route in a packet switching network, the computer readable program codes include:
a first computer readable program code for causing said computer to receive a reservation request for the file transfer from a sender or a receiver if the node device is the ingress node;
a second computer readable program code for causing said computer to carry out a control processing for determining a reserved rate function rrsv(t) indicating an output bandwidth at the node device as a function of time t according to an input rate function rin(t) indicating an input bandwidth at the node device as a function of time t and a vacant rate function rφ(t) indicating a vacant bandwidth at the node device as a function of time t, and judging whether it is possible to accept the reservation request at the node device or not according to whether a difference between the input rate function and the output rate function exceeds a buffer capacity available at the node device or not;
a third computer readable program code for causing said computer to transfer the reservation request to a next hop node on the file transfer route when it is possible to accept the reservation request at the node device, or reject the reservation request when it is not possible to accept the reservation request at the node device, if the node device is one of the ingress node and the core nodes;
a fourth computer readable program code for causing said computer to accept the reservation request when it is possible to accept the reservation request, or reject the reservation request otherwise, if the node device is the egress node; and
a fifth computer readable program code for causing said computer to reserve the output bandwidth at the node device as indicated by the reserved rate function rrsv(t) of the node device when the reservation request is accepted.

42. The computer usable medium of claim 31, wherein the first computer readable program code receives the reservation request indicating a file size B of a file to be transferred, an input rate rin by which the file is to be transmitted from the sender to the packet switching network, and a time ts at which input of file data from the sender to the packet switching network starts, and sets the input rate function rin(t) of the node device as rin(t)=rin[ts, tₛ+B/rin).

43. The computer usable medium of claim 41, wherein the second computer readable program code carries out the control processing by obtaining a time tx at which an input data amount and an output data amount at the node device coincide according to the input rate function rin(t) and the vacant rate function rφ(t), and setting the reserved rate function rrsv(t) at the node device as rrsv(t)=rφ(t) (ts,≦t<tx), rrsv(t)=rin(t) (t≧tx), where ts is a time at which input of file data from the sender to the packet switching network starts.

44. The computer usable medium of claim 41, wherein the second computer readable program code carries out the control processing by judging whether ∫rin(t)dt[ts, t)−∫rrsv(t)dt[ts, t) exceeds the buffer capacity available at the node device or not, where ts is a time at which input of file data from the sender to the packet switching network starts.

45. The computer usable medium of claim 41, wherein when the node device is one of the ingress node and the core nodes and the second computer readable program code judges that it is possible to accept the reservation request, the third computer readable program code transfers the reservation request to the next hop node at the step (c) by indicating the input rate function rin(t) of the next hop node according to the reserved rate function rrsv(t) of the node device.

46. The computer usable medium of claim 45, wherein the third computer readable program code indicates the reserved rate function rrsv(t) of the node device as the input rate function rin(t) of the next hop node.

47. The computer usable medium of claim 45, wherein the third computer readable program code generates two approximate functions rΛ(t) and rY(t) for approximating the reserved rate function rrsv(t) of the node device such that ∫rΛ(t)dt≦∫rrsv(t)dt≦∫rY(t)dt (∀t), and indicates rΛ(t) as the input rate function rin(t) of the next hop node.

48. The computer usable medium of claim 47, wherein when the node device is one of the core nodes and the egress node, the second computer readable program code carries out the control processing by judging whether ∫rin(t)dt[ts, t)−∫rrsv(t)dt[ts, t)+{∫rΛ(t)dt−∫rY(t)dt}[ts, t) exceeds the buffer capacity available at the node device or not, where ts is a time at which input of file data from the sender to the packet switching network starts.

49. The computer usable medium of claim 41, wherein when the reservation request is accepted and the node device is the egress node, the fourth computer readable program code notifies an acceptance of the reservation request to the sender or the receiver along with a predicted file transfer completion time.

50. A computer usable medium having computer readable program codes embodied therein for causing a computer to function as a node device for carrying out a packet scheduling in a packet switching network for transferring packets of a file from a sender to a receiver, as one of an ingress node, core nodes, and an egress node on a file transfer route, the computer readable program codes include:
a first computer readable program code for causing said computer to set a deadline td for transmitting each packet at the node device on a file transfer route, as td=max[tarv+l/rin, tx], where tarv is an arrival time of each packet at the node device, l is a packet length, rin is an input rate by which the file is to be transmitted from the sender to the packet switching network, and tx is a time at which an input data amount and an output data amount at the node device coincide; and
a second computer readable program code for causing said computer to select one packet among packets buffered in the node device which has the deadline td that is smallest among the packets buffered in the node device, and transmit said one packet from the node device.
